(19) United States
(12) Patent Application Publication
(10) Pub. No.: US 2025/0123494 A1
(43) Pub. Date: Apr. 17, 2025

(54) LIQUID CRYSTAL ALIGNMENT MEMBER FOR SPATIAL LIGHT PHASE MODULATION, SPATIAL LIGHT MODULATION ELEMENT AND STEREOSCOPIC DISPLAY DEVICE

(71) Applicants: DAI NIPPON PRINTING CO., LTD., Tokyo-to (JP); TOHOKU UNIVERSITY, Sendai-shi, Miyagi (JP)

(72) Inventors: Kazuo SASAMOTO, Tokyo-to (JP); Rie KUSAMA, Tokyo-to (JP); Hideo FUJIKAKE, Miyagi (JP); Takahiro ISHINABE, Miyagi (JP); Yosei SHIBATA, Miyagi (JP); Kisho YAMAMOTO, Miyagi (JP)

(73) Assignees: DAI NIPPON PRINTING CO., LTD., Tokyo-to (JP); TOHOKU UNIVERSITY, Sendai-shi, Miyagi (JP)

(21) Appl. No.: 18/713,890

(22) PCT Filed: Nov. 28, 2022
(86) PCT No.: PCT/JP2022/043702

§ 371 Date: Dec. 16, 2024

(30) Foreign Application Priority Data
Nov. 29, 2021 (JP) 2021-193443

(51) Int. Cl. G02B 30/26; G02F 1/1337; G02F 1/1343; G02F 1/136

(52) U.S. Cl. CPC G02B 30/26; G02F 1/1337; G02F 1/134309; G02F 1/13613; G02F 2203/02

(57) ABSTRACT

A liquid crystal alignment member for spatial light phase modulation includes: a silicon substrate; a base portion including pixel electrodes arranged in a matrix with a period of 3 μm or less; a lattice-shaped wall structure configured by a dielectric material; a base layer connected to the lattice-shaped wall structure; and a plurality of liquid crystal-filling microspace separated from each other by the lattice-shaped wall structure, wherein the lattice-shaped wall structure is arranged at least between adjacent pixel regions; the liquid crystal-filling microspace includes a shape anisotropy in a first axial direction and a second axial direction in a plane parallel to the base portion; when W_{A} is a space width of the first axial direction and W_{B} is a space width of the second axial direction, W_{A} is smaller than W_{B}; and a base groove extending to the second axial direction is formed in the base layer.

### TECHNICAL FIELD

The present disclosure relates to a liquid crystal alignment member for spatial light phase modulation, a spatial light modulation element and a stereoscopic display device.

### BACKGROUND ART

To a stereoscopic display, not only applications in the field of broadcasting and communication such as television broadcasting and a video telephone, applications in a variety of fields including the medical field, the manufacturing industry and education have been expected. In recent years, along with the development of augmented reality (AR) technology and virtual reality (VR) technology, a stereoscopic display that stereoscopically displays a stereoscopic image and a virtual space has been suggested. Among those, a holographic display is expected to be in a practical use as a stereoscopic display in the next generation, since natural stereoscopic display satisfying all the physiologic factors of a stereoscopic view is possible. The holographic display is a display that displays a stereoscopic image by modifying the light with high interference such as a laser light source, and reproducing a wavefront of light of an object. The light of the light source is modified by a light modulation element that displays a hologram (interference fringes), and the direction and strength of light of the object are reproduced by the interference generated in the process of light propagation. As the modification methods of the light modulation element, there are an amplitude method for reproducing the amplitude distribution of the two-dimensional light, and a phase method (phase modulation element) for reproducing the phase distribution of the light. Among them, the phase method is considered a useful method for the practical use since the utilization efficiency of light is higher than that of the former method, and is advantageous in being capable of inhibiting the higher order diffraction light that disturbs the observation of the reproduced image.

A spatial light phase modulation element using a liquid crystal LCOS-SLM (Liquid Crystal on Silicon-Spatial Light Modulator) is a reflection type optical device having a structure in which a liquid crystal is sandwiched between a glass substrate including a transparent common electrode, and a driving electrode that is aligned on a silicon back plane and also works as a reflection plate. An inorganic/organic thin film called an alignment film is formed in the interface of the liquid crystal and the common/driving electrode, and in the liquid crystal method of horizontal alignment, the liquid crystal molecules are constrained such that the longer axis direction of the molecule is defined in one direction in the plane by the orientation regulating force received from the alignment film, and at the same time, the longer axis is in the horizontal direction with respect to the substrate. For this reason, when no electric field is applied, the liquid crystal is horizontally oriented to the substrate. At this time, when linearly polarized light vibrating in parallel with the longer axis direction of the liquid crystal molecules is incident, the refractive index felt by the incident light is in a high state. On the other hand, when the electric field is applied, since the liquid crystal molecules rotate due to dielectric anisotropy so that the direction of the electric power line and the longer axis are close to parallel, the refractive index felt by the incident linearly polarized light is in a low state. As a result, the phase difference occurs between the light that reflects the pixel in the ON state and the light that reflects the pixel in the OFF state, and thus it is possible to obtain a two-dimensional distribution of the phase by applying the electric field in each pixel.

### CITATION LIST

### Non-Patent Documents

Non-Patent Document 1: Y. Isomae, Y. Shibata, T. Ishinabe, and H. Fujikake, “Design of 1-maikurom-pitch liquid crystal spatial light modulators having dielectric shield wall structure for holographic display with wide field of view,” Opt. Rev., vol. 24, no. 2, pp. 165-176, April 2017. DOI: 10.1007/s10043-017-0316-0
Patent Document 2: Y. Isomae et al., Experimental study of 1-μm-pitch light modulation of a liquid crystal separated by dielectric shield walls formed by nanoimprint technology for electronic holographic displays, Opt. Eng. 57 (6), 061624 (2018).

### Patent Document

Patent Document 1: Japanese Patent Application Laid-Open (JP-A) No. 2020-187345

### SUMMARY

### Technical Problem

Since the holographic display reproduce the object light by interference of light, the angle range (visual range angle) where the reproduced image can be observed depends on the maximum diffraction angle determined by the pixel pitch of the spatial light phase modulation element.

The inventors have investigated the pixel pitch required to achieve a practical holographic display. Specifically, the inventors have considered that a viewing environment in which a portable terminal such as a tablet is placed on a table is assumed, and an image of a size of one side 20 cm is reproduced at a position separated by 50 cm. In this case, a visual field angle of 30° is theoretically required. When the viewing angle of 30° is to be achieved, the pixel pitch required for the phase modulation element is approximately 1 μm as the calculation result obtained.

However, currently, the minimum pixel pitch of the phase modulation element that is actually implemented is 3.74 μm, and when the wavelength of light is 550 nm, the visual angle is 8.4°. Thus, in order to achieve a practical holographic display, narrowing the pitch of pixels of the spatial light phase modulation element is required.

According to the present inventors, in a minute pixel of about 1 μm pitch, independent driving for each pixel becomes difficult due to leak of the electric field and propagation of elastic force of liquid crystal alignment, and it has been found that contrast decreases.

Also, according to a simulation based on the continuous elastic body theory, when the pixel pitch becomes 3 μm or less, an electric field at the time of driving the pixel electrode is propagated onto the adjacent pixel, and it has become clear that some liquid crystals rotate (see Non-Patent Document 1).

The inventors have proposed a dielectric shield wall structure as a pixel structure from such a background (Non Patent Document 2). The dielectric shield wall structure has a dielectric wall formed between the pixel and the pixel.

Here, in the liquid crystal device, formation of an alignment film is required for both the pixel electrode side and the counter electrode (common electrode) side, but it has been found that it is difficult to form the alignment film on the pixel electrode side after forming the dielectric shield wall structure having a high aspect structure such as the above-described technology. For example, when a rubbing method or a photo-alignment method that is mainly used in a manufacturing process of a liquid crystal flat panel display is used, there has been a problem that it is difficult to apply an alignment film material onto a substrate on which a high aspect structure body is formed. Thus, it has been difficult to control the alignment of the liquid crystal, and it has been difficult to align the orientation of the alignment of the liquid crystal.

Then, the inventors have further studied and found that the structure itself has a self-organized liquid crystal alignment function and the alignment can be regulated by utilizing the elasticity of the liquid crystal by providing shape anisotropy for one or two or more liquid crystal-filling microspace corresponding to each of the pixel electrodes having a narrow pixel pitch of 3 μm or less, in mutually orthogonal direction in a base portion plane (Patent Document 1).

On the other hand, as the miniaturization proceeds, a liquid crystal alignment member for spatial light phase modulation having a stronger alignment regulating force is required.

The present disclosure has been made in view of the above circumstances, and a main object thereof is to provide a liquid crystal alignment member for spatial light phase modulation having a high liquid crystal alignment regulation force and capable of obtaining a spatial light modulation element having a pixel electrode pitch of 3 μm or less.

### Solution to Problem

One embodiment of the present disclosure provides a liquid crystal alignment member for spatial light phase modulation comprising: a base portion including a silicon substrate, and pixel electrodes arranged in a matrix with a period of 3 μm or less, disposed on a surface of the silicon substrate; a lattice-shaped wall structure in which a plurality of linear convex part is combined, arranged on the base portion and configured by a dielectric material; a base layer configured by the dielectric material, connected to the lattice-shaped wall structure; and a plurality of liquid crystal-filling microspace for filling a liquid crystal, that is separated from each other by the lattice-shaped wall structure, and is disposed on the base layer, wherein the lattice-shaped wall structure is arranged at least between pixel regions where adjacent the pixel electrodes are formed; when a first axis and a second axis are designed so as to orthogonal to each other in a plane parallel to the base portion, the liquid crystal-filling microspace includes shape anisotropy in a first axial direction and a second axial direction; when W_{A} is a space width of the first axial direction and W_{B} is a space width of the second axial direction, the W_{A} is a smaller value than the W_{B}; and the base layer is a base layer with a groove, in which a base groove extending to the second axial direction of the liquid crystal-filling microspace is formed.

In the liquid crystal alignment member for spatial light phase modulation of the present embodiment, when a liquid crystal is filled and used as a light modulation element, electric field leakage from adjacent pixels and propagation of liquid crystal elastic force can be blocked even when the pixel pitch is narrow to 3 μm or less. Also, at the same time, since one or two or more liquid crystal-filling microspace corresponding to each of the pixel electrodes having a narrow pixel pitch of 3 μm or less, has shape anisotropy in a direction orthogonal to each other on the base portion plane, the structure itself has a liquid crystal alignment function, so that the orientation of the liquid crystal can be aligned. Further, since the liquid crystal-filling microspace having the shape anisotropy is provided on the base layer including a base groove extending to the second axial direction (longer axial direction), the orientation of the liquid crystal can be more accurately controlled.

Also, regarding the base groove, two or more of the base groove are preferably arranged in the base layer corresponding to each of the liquid crystal-filling microspace.

One embodiment of the present disclosure provides a liquid crystal alignment member for spatial light phase modulation comprising: a base portion including a silicon substrate, and pixel electrodes arranged in a matrix with a period of 3 μm or less, disposed on a surface of the silicon substrate; a lattice-shaped wall structure in which a plurality of linear convex part is combined, arranged on the base portion and configured by a dielectric material; a base layer configured by the dielectric material, connected to the lattice-shaped wall structure; and a plurality of liquid crystal-filling microspace for filling a liquid crystal, that is separated from each other by the lattice-shaped wall structure, and is disposed on the base layer, wherein the lattice-shaped wall structure is arranged at least between pixel regions where adjacent the pixel electrodes are formed; when a first axis and a second axis are designed so as to orthogonal to each other in a plane parallel to the base portion, the liquid crystal-filling microspace includes shape anisotropy in a first axial direction and a second axial direction; when W_{A} is a space width of the first axial direction and W_{B} is a space width of the second axial direction, the W_{A} is a smaller value than the W_{B}; and the base layer is an uneven thickness base layer of which thickness differs in one end and in the other end, in the second axial direction of the liquid crystal-filling microspace.

In the present embodiment, the uneven thickness base layer can impart a pre-tilt angle slightly inclined with respect to the base portion plane, to the liquid crystal molecules, due to the difference in the thickness in one end and the other end in the second axial direction of the liquid crystal-filling microspace, and the orientation of the liquid crystal can be more accurately controlled.

In this case, in the uneven thickness base layer, it is preferable that the thickness differs in one end and in the other end by including at least one of a slope or a step in the second axial direction of the liquid crystal-filling microspace.

Also, in the present disclosure, the W_{A} is preferably 3 μm or less. In such a value, a sufficient liquid crystal alignment function can be provided as the liquid crystal alignment member.

Also, it is preferable that a ratio of the W_{B} with respect to the W_{A}, which is W_{B}/W_{A} is 2 or more. In this range, since the shape anisotropy in the first axial direction and the second axial direction in a plane parallel to the base portion is sufficient, the alignment of the liquid crystal can be certainly controlled by utilizing the elasticity of the liquid crystal to be filled.

One embodiment of the present disclosure provides a spatial light modulation element that is a reflecting type spatial light phase modulation element controlling a phase of incident light and reflected light while reflecting an incident light, the spatial light modulation element comprising: a transparent substrate, a common electrode arranged on one surface of the transparent substrate, the above described liquid crystal alignment member for spatial light phase modulation arranged on a surface of the common electrode that is opposite side to the transparent substrate, and a liquid crystal layer filled in the liquid crystal-filling microspace of the liquid crystal alignment member for spatial light phase modulation. In order to further stabilize the liquid crystal alignment function, an alignment film may be arranged between the common electrode and the above described liquid crystal alignment member for spatial light phase modulation.

Also, one embodiment of the present disclosure provides a stereoscopic display device comprising the above described spatial light modulation element, and a driving measure for driving the pixel electrodes.

In the spatial light modulation element and the stereoscopic display device of the present disclosure, even when the pitch of the pixel electrodes is a narrow pitch such as 3 μm or less, it is possible to easily control the orientation of the liquid crystal independently in each pixel.

One embodiment of the present disclosure provides a liquid crystal alignment member for spatial light phase modulation comprising: a base portion including a silicon substrate, and pixel electrodes arranged in a matrix with a period of 3 μm or less disposed on a surface of the silicon substrate; a lattice-shaped high wall structure in which a plurality of linear convex part is combined, arranged on the base portion and configured by a dielectric material; and a plurality of liquid crystal-filling microspace for filling a liquid crystal, that is separated from each other by the lattice-shaped high wall structure, wherein the lattice-shaped high wall structure is arranged at least between pixel regions where adjacent the pixel electrodes are formed; when a first axis and a second axis are designed so as to orthogonal to each other in a plane parallel to the base portion, and a third axis is further designed so as to vertical to a plane parallel to the base portion, and when in the liquid crystal-filling microspace, W_{3A} is a space width of the first axial direction, W_{3B} is a space width of a second axial direction, and W_{3C} is a space width of a third axial direction, the W_{3C} is larger than the W_{3A} and the W_{3B}, and at least one of W_{3C}/W_{3A} and W_{3C}/W_{3B} is 1.1 or more.

In the present embodiment, at least one of the W_{3C}/W_{3A} and the W_{3C}/W_{3B} is preferably 1.3 or more. In this range, since the shape anisotropy is sufficient between the first axial direction or the second axial direction in a plane parallel to the base portion, and the third axial direction vertical to the plane parallel to the base portion, the alignment of the liquid crystal can be certainly controlled by utilizing the elasticity of the liquid crystal to be filled.

Also, the W_{3C} is, for example, preferably 800 nm or more. In this range, the shape anisotropy tends to be sufficient in the first axial direction or the second axial direction in a plane parallel to the base portion, and in the third axial direction vertical to the plane parallel to the base portion.

Also, in the present embodiment, the lattice-shaped high wall structure preferably includes a wall groove extending to the third axial direction in one surface or more among four surfaces facing to the liquid crystal-filling microspace. Since the wall groove extending to the third axial direction that is the longer axial direction of the liquid crystal-filling microspace is formed in the high wall structure, the liquid crystal molecules are aligned along the wall groove extending to the longer axial direction, and thus higher alignment regulation force can be provided and it is possible to control the orientation of the liquid crystal with high accuracy.

Also, the in the present embodiment, further preferably provided is a base layer that is connected to the lattice-shaped high wall structure, and is surrounding both of the lattice-shaped high wall structure and the liquid crystal-filling microspace, wherein, the base layer is configured by the dielectric material, and a thickness of the base layer differs in one end and in the other end, in the first axial direction or the second axial direction of the liquid crystal-filling microspace. The reason therefor is that a pre-tilt angle slightly inclined with respect to the base portion plane can be imparted to the liquid crystal molecules when the voltage is applied.

Also, in this case, it is preferable that the base layer includes at least one of a slope and a step in the first axial direction or the second axial direction of the liquid crystal-filling microspace, so that the thickness differs in one end and the other end.

One embodiment of the present disclosure provides a spatial light modulation element that is a reflecting type spatial light phase modulation element controlling a phase of incident light and reflected light while reflecting an incident light, the spatial light modulation element comprising: a transparent substrate, a common electrode arranged on one surface of the transparent substrate, the above described liquid crystal alignment member for spatial light phase modulation according arranged on a surface of the common electrode that is opposite side to the transparent substrate, and a liquid crystal layer filled in the liquid crystal-filling microspace of the liquid crystal alignment member for spatial light phase modulation.

Also, one embodiment of the present disclosure provides a stereoscopic display device comprising the above described spatial light modulation element, and a driving measure for driving the pixel electrodes.

In the spatial light modulation element and the stereoscopic display device of the present disclosure, even when the pitch of the pixel electrode is a narrow pitch such as 3 μm or less, it is possible to easily control the orientation of the liquid crystal independently in each pixel.

### Advantageous Effects

The present disclosure exhibits an effect of providing a liquid crystal alignment member for spatial light phase modulation with which a spatial light modulation element with high alignment regulation force of liquid crystal having pixel electrode pitch of 3 μm or less can be obtained. Also, the present disclosure can provide a spatial light modulation element and a stereoscopic display device that are useful for ultra-high-definition projectors, holographic displays using optical diffraction, and the like.

### BRIEF DESCRIPTION OF DRAWINGS

FIG. 1 is a top view and a schematic cross-sectional view illustrating an example of a liquid crystal horizontal alignment member for spatial light phase modulation, and a top view of the base portion of the first embodiment of the present disclosure.

FIG. 2 is a top view and a schematic cross-sectional view illustrating an example of a liquid crystal horizontal alignment member for spatial light phase modulation, and a top view of the base portion of the first embodiment of the present disclosure.

FIG. 3 is a top view and a schematic cross-sectional view illustrating an example of the liquid crystal horizontal alignment member for spatial light phase modulation of the first embodiment of the present disclosure.

FIG. 4 is a top view and a schematic cross-sectional view illustrating an example of the liquid crystal horizontal alignment member for spatial light phase modulation of the second embodiment of the present disclosure.

FIG. 5 is a top view and a schematic cross-sectional view illustrating an example of the liquid crystal horizontal alignment member for spatial light phase modulation of the second embodiment of the present disclosure.

FIG. 6 is a top view and a schematic cross-sectional view illustrating an example of the liquid crystal horizontal alignment member for spatial light phase modulation of the second embodiment of the present disclosure.

FIG. 7 is a top view and a schematic cross-sectional view illustrating an example of the liquid crystal horizontal alignment member for spatial light phase modulation of the second embodiment of the present disclosure.

FIG. 8 is a top view, a schematic cross-sectional view illustrating an example of a liquid crystal vertical alignment member for spatial light phase modulation, and a top view of the base portion of the third embodiment of the present disclosure.

FIG. 9 is a top view and a schematic cross-sectional view illustrating an example of the liquid crystal vertical alignment member for spatial light phase modulation of the third embodiment of the present disclosure.

FIG. 10 is a top view and a schematic cross-sectional view illustrating an example of the liquid crystal vertical alignment member for spatial light phase modulation of the third embodiment of the present disclosure.

FIG. 11 a top view and a schematic cross-sectional view illustrating an example of the liquid crystal vertical alignment member for spatial light phase modulation of the third embodiment of the present disclosure.

FIG. 12 is a top view and a schematic cross-sectional view illustrating an example of the liquid crystal vertical alignment member for spatial light phase modulation of the third embodiment of the present disclosure.

FIG. 13 is a top view and a schematic cross-sectional view illustrating an example of the liquid crystal vertical alignment member for spatial light phase modulation of the third embodiment of the present disclosure.

FIG. 14 is a top view and a schematic cross-sectional view illustrating an example of the liquid crystal vertical alignment member for spatial light phase modulation of the third embodiment of the present disclosure.

FIG. 15 is a schematic cross-sectional view illustrating an example of the spatial light phase modulation element (first embodiment) of the present disclosure.

FIG. 16 is a schematic cross-sectional view illustrating the base layer and the lattice-shaped wall structure produced in Examples.

FIG. 17 is polarizing microscope observation results in Example 1.

FIG. 18 is a top view of samples for evaluating the alignment members of Examples and Comparative Examples.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present description and each drawing, for the factor same as that described in the figure already explained, the same reference sign is indicated and the explanation thereof may be omitted.

In the present description, upon expressing an aspect of arranging one member on the other member, when it is expressed simply “on” or “below”, both of when the other member is directly arranged on or below the one member so as to contact with each other, and when the other member is arranged above or below the one member further interposing an additional member, can be included unless otherwise described. Also, in the present descriptions, on the occasion of expressing an aspect wherein some member is placed on the surface of the other member, when described as merely “on the surface side” or “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

As a result of the inventors' intensive studies to solve the above problem, it has been found that the above problem can be solved with the liquid crystal alignment members for spatial light phase modulation according to the first embodiment to the third embodiment described later, and the present invention has been achieved. The first embodiment and the second embodiment relate to a liquid crystal horizontal alignment member for spatial light phase modulation capable of orienting liquid crystal molecules in a direction substantially horizontal to the base portion when no voltage is applied to the liquid crystal layer, and the third embodiment relates to a liquid crystal vertical alignment member for spatial light phase modulation capable of orienting liquid crystal molecules in a direction substantially vertical to the base portion when no voltage is applied to the liquid crystal layer.

### A. Liquid Crystal Alignment Member for Spatial Light Phase Modulation (First Embodiment)

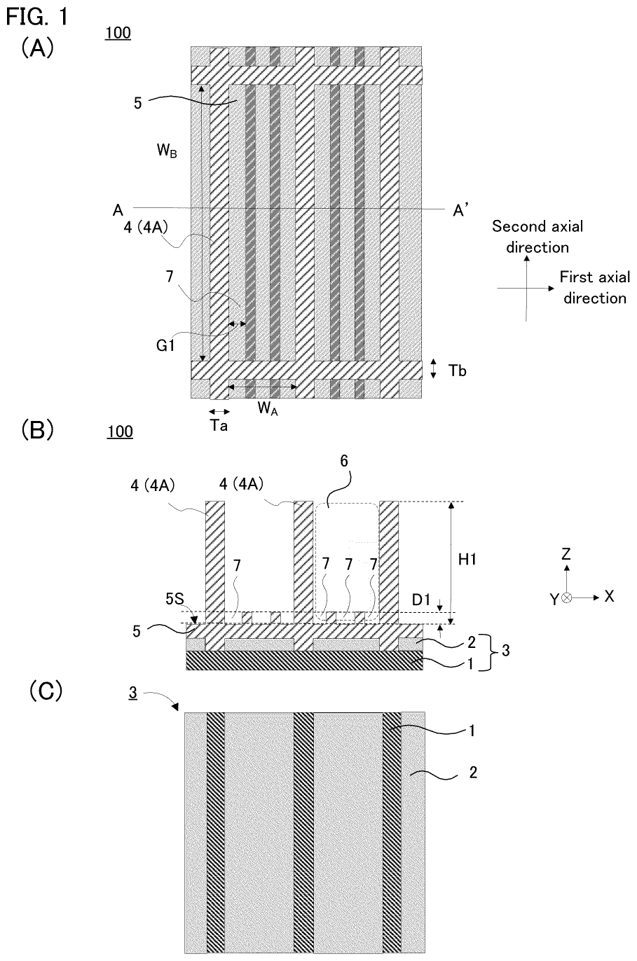

The liquid crystal alignment member for spatial light phase modulation (hereinafter also simply referred to as alignment member) of the present embodiment will be explained with reference to drawings. FIG. 1(A) is a top view illustrating an example of the alignment member of the present embodiment, FIG. 1(B) is a schematic cross-sectional view of A-A′ in FIG. 1(A), and FIG. 1(C) is a top view of the base portion in FIG. 1(B).

As shown in FIG. 1, alignment member 100 of the present embodiment includes base portion 3 including substrate 1, and pixel electrodes 2 arranged in a matrix with a period of 3 μm or less, disposed on a surface of the substrate 1; lattice-shaped wall structure 4 in which a plurality of linear convex part is combined, arranged on the base portion 3 and configured by a dielectric material; base layer 5 configured by the dielectric material, connected to the lattice-shaped wall structure 4; and a plurality of liquid crystal-filling microspace 6 for filling a liquid crystal, that is separated from each other by the lattice-shaped wall structure 4, and is disposed on the base layer 5.

The lattice-shaped wall structure 4 is arranged at least between pixel regions where adjacent the pixel electrodes 2 are formed. In FIG. 1, the first axial direction is taken in the X-axial direction, which is the matrix direction of the pixel electrodes, and the second axial direction is taken in a direction (Y-axial direction) orthogonal to the first axial direction in a plane parallel to the base portion. The liquid crystal-filling microspace 6 separated from each other by the lattice-shaped wall structure 4 has anisotropy in the shape in the first axial direction and the second axial direction orthogonal to each other in the base portion plane, and the space width W_{B} in the second axial direction is longer than the space width W_{A} in the first axial direction. Further, in the base layer 5 surrounding the liquid crystal-filling microspace 6 together with the lattice-shaped wall structure 4, base groove 7 extending to the second axial direction that is the longer axial direction, is formed. In FIG. 1, one liquid crystal-filling microspace 6 is formed on one pixel electrode 2.

With the liquid crystal alignment member for spatial light phase modulation of the present embodiment, since the lattice-shaped wall structure is arranged at least between pixel regions where adjacent the pixel electrodes are formed, and the liquid crystal-filling microspace is separated from each other by the lattice-shaped wall structure, when a liquid crystal is filled and used as a light modulation element, electric field leakage from adjacent pixels and propagation of liquid crystal elastic force can be blocked even when the pixel pitch is narrow to 3 μm or less. Also, at the same time, since one or two or more of the liquid crystal-filling microspace corresponding to each of pixel electrodes having a narrow pixel pitch of 3 μm or less, includes shape anisotropy in a direction (first axial direction and second axial direction) orthogonal to each other in a plane parallel to the base portion, the structure itself can have a liquid crystal alignment function, and thus orientation of the liquid crystal can be aligned even when there is no alignment film on the base portion. Therefore, it is possible to easily control the orientation of the liquid crystal independently in each pixel. Further, in the present embodiment, in the base layer surrounding the liquid crystal-filling microspace together with the lattice-shaped wall structure, a base groove extending to the second axial direction, which is the longer axis direction of the liquid crystal-filling microspace, is formed. Thus, since the liquid crystal molecules are aligned along the base groove extending to the longer axis direction, higher alignment regulation force can be provided and it is possible to control the orientation of the liquid crystal with high accuracy.

Note that the liquid crystal alignment member for spatial light phase modulation in the present embodiment is a liquid crystal horizontal alignment member for spatial light phase modulation capable of orienting the liquid crystal molecules in a direction substantially horizontal to the base portion when no voltage is applied to the liquid crystal layer. The alignment member of the present embodiment will be hereinafter described in details.

### 1. Silicon Substrate

In the present embodiment, the substrate where the pixel electrodes are disposed, is a silicon substrate. The silicon substrate is capable of producing a fine device such as one with a period of the pixel electrodes of 3 μm or less. The film thickness of the silicon substrate is not particularly limited, but is usually within the range of 280 μm or more and 775 μm or less. Also, the size in a plan view is usually about 50 mmφ or more and 300 mmφ or less.

### 2. Pixel Electrodes

The pixel electrodes for driving the display pixels in the present embodiment are arranged in a matrix with a period of 3 μm or less, on a surface of the silicon substrate. A plurality of pixels of the spatial light modulation element are defined by these pixel electrodes. “In a matrix” may be a one-dimensional matrix that is the arrangement only in the X-axial direction, or may be a two-dimensional matrix that is the arrangement in the X-axial direction and the Y-axial direction orthogonal to the X-axial direction. Typically, the pixel electrodes are arranged in a two-dimensional matrix.

In the present embodiment, the period of the pixel electrodes refers to the center-to-center distance between adjacent pixel electrodes. Also, when the pixel electrodes are arranged in the one-dimensional matrix, the period of the adjacent pixel electrodes is 3 μm or less, and when the pixel electrodes are arranged in the two-dimensional matrix in the X-axial direction and the Y-axial direction, in the case where the periods in the X-axial direction and in the Y-axial direction are the same, the periods are 3 μm or less, and in the case where the periods are different, the shorter period is 3 μm or less. In the present embodiment, when the pixel electrodes are arranged in the two-dimensional matrix, it is preferable that both periods in the X-axial direction and in the Y-axial direction are 3 μm or less.

In this manner, even when the pixel pitch is narrow to 3 μm or less, with the alignment member of the present embodiment, the liquid crystal can be controlled independently for each pixel region when filled with a liquid crystal to be a light modulation element. In the present embodiment, the period may be 3 μm or less (at this time, the viewing angle is about 10° or more), but it is preferably 1 μm or less since the practical viewing angle 30° can be obtained thereby.

The surface of the pixel electrode is usually processed to be flat and smooth, and the pixel electrodes on the silicon substrate may include a function as a reflector.

The pixel electrode is not particularly limited as long as it is configured by a material with conductivity, and examples thereof may include Al, Cr, Cu, Ag, Ta, Mo, Nd, and an alloy of these. Further, a dielectric multilayer with high reflectivity may be layered on its surface.

The shape of the pixel electrode in a plan view is not particularly limited, but it is usually either of rectangular or square. Also, the size of the pixel electrode is not particularly limited as long as the size allows the period of the pixel electrodes to be 3 μm or less.

The thickness of the pixel electrode is not particularly limited as long as the thickness ensures the conductivity, and the known techniques can be used. Also, the arrangement of the pixel electrodes is desired to be in a matrix of XY directions, but is not limited thereto.

The method for forming the pixel electrode is not particularly limited if the method allows the formation of the desired thickness and pattern, and general method for forming the pixel electrode layer can be used. Specific examples thereof may include a PVD (physical vapor deposition) method such as a vapor deposition method, a spattering method, and an ion plating method, a CVD (chemical vapor deposition) method, a method in which a conductive paste is pasted, an ink-jet method, a screen printing method, a flexographic printing method, and a plating method.

### 3. Base Portion

The base portion in the present embodiment includes at least a silicon substrate and pixel electrodes. The silicon substrate and the pixel electrodes are the same as those explained in “1. Silicon substrate”, and “2. Pixel electrodes” above; thus, the descriptions herein are omitted.

### 4. Lattice-Shaped Wall Structure

The lattice-shaped wall structure in the present embodiment is formed on the base portion, is configured by a dielectric material, and includes a structure in which a plurality of linear convex part is combined.

In the present embodiment, the material configuring the lattice-shaped wall structure is not particularly limited as long as it is a dielectric material and is a material that allows a fine processing such as a nano imprinting method and an etching method. Among dielectric materials, the lattice-shaped wall structure is preferably formed of a low dielectric material, and particularly preferably is formed of a material with the dielectric constant of 4.0 or less, and further preferably is formed of a material with the dielectric constant of 2.0 or less.

Specific examples of the material that allows a nano-imprinting processing may include a thermosetting resin and a photocurable resin, but in particular, it is preferably the photocurable resin. Also, when it is the photocurable resin, it is preferably a transparent resin.

As the material configuring such a lattice-shaped wall structure, above all, an acrylic resin, a coating type glass, glass and the like are preferable.

Also, by using a material formed by mixing a black pigment with the above material, light not modified can be absorbed. Such a black pigment is the same as that to be described in the section “A. Liquid crystal alignment member for spatial light phase modulation 7. Others (2) Light absorbing layer” later; thus, the description herein is omitted.

The lattice-shaped wall structure is a structure in which a plurality of linear convex part is combined, and is preferably a structure in which linear convex parts orthogonal to each other are combined. For example, it is the structure in which a linear convex part extending to the first axial direction and a linear convex part extending to the second axial direction orthogonal to the first axial direction are combined so as to cross each other.

The thickness of the lattice-shaped wall structure is not particularly limited, but it is preferably 50 nm or more and 400 nm or less, and further preferably 200 nm or less.

Here, the thickness of the lattice-shaped wall structure refers to, as indicated with (Ta) and (Tb) in FIG. 1, the thickness in non-crossing part of the linear convex part.

Also, the height of the lattice-shaped wall structure is not particularly limited, but the height is preferably 500 nm or more and 3000 nm or less, and further preferably 800 nm or more and 1500 nm or less.

Here, as indicated with (H1) in FIG. 1, the height of the lattice-shaped wall structure 4 refers to the maximum distance of a length from first surface 5S of the base layer 5 until the top part of the lattice-shaped wall structure 4 (linear convex part) (in specific, in FIGS. 1A to 1C, the maximum distance of a length from the bottom surface of the base groove 7 formed in the base layer 5 until the top part of the lattice-shaped wall structure 4 (linear convex part)), in a vertical direction to the in-plane direction of the base layer 5.

In the present embodiment, the height H1 of all the linear convex parts included in the wall structure 4 is preferably in the above numerical range. The height H1 of the wall structure 4 can be, for example, measured using a scanning electron microscope and the like.

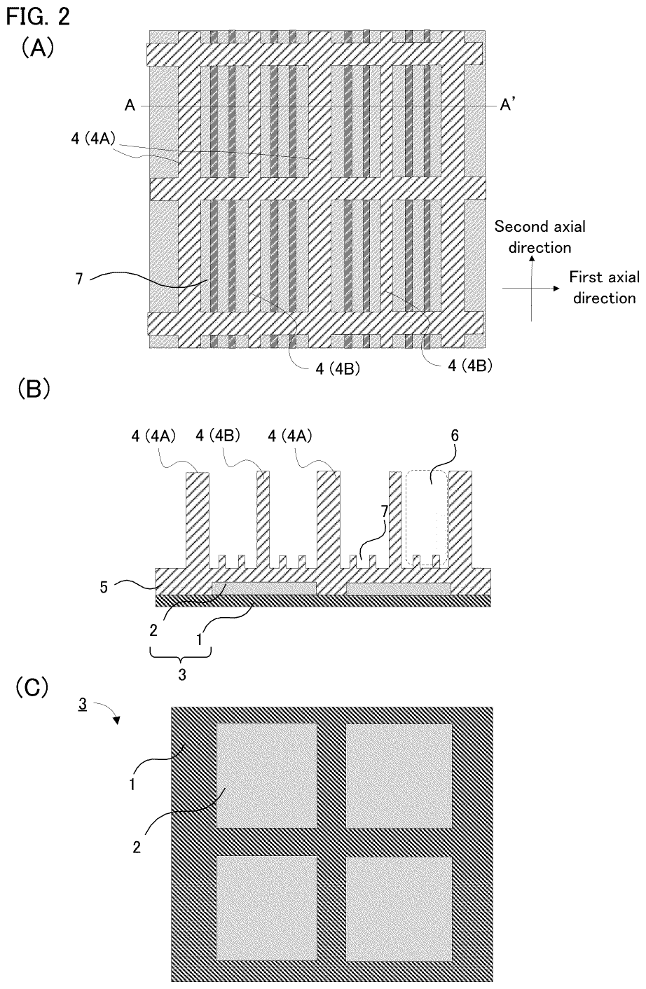

In the present embodiment, as shown in FIG. 2, the lattice-shaped wall structure 4 can be roughly classified into wall part 4A arranged between the adjacent pixel electrode regions, and partition part 4B that divides one pixel electrode region into two or more. FIG. 2(A) is a top view illustrating an example of the alignment member of the present embodiment, FIG. 2(B) is a schematic cross-sectional view of A-A′ in FIG. 2(A), and FIG. 2(C) is a drawing that shows the arrangement of the pixel electrodes. The wall part and the partition part will be hereinafter described separately in details.

### (1) Wall Part

The wall part is disposed so as to divide the adjacent pixel regions, that is, to surround each pixel region. When the pixel region does not include the shape anisotropy as shown in FIG. 2, it is necessary to dispose the later described partition part, but when the pixel region itself includes the shape anisotropy as shown in FIG. 1, the lattice-shaped wall structure 4 may be configured by only the wall part 4A.

### (a) Thickness

The thickness of the wall part is not particularly limited, but it is preferably 180 nm or more and 400 nm or less. It is further preferably 180 nm or more and 250 nm or less. With the above value or less, the liquid crystal-filling microspace with sufficient width can be secured. Also, with the above value or more, the leakage of the electric field from the adjacent pixel and the propagation of the elastic force of the liquid crystal orientation can be certainly blocked, and thus it is possible to control the orientation of the liquid crystal to be filled in.

### (b) Height

The height of the wall part is not particularly limited, but is preferably 500 nm or more and 3000 nm or less, and further preferably 800 nm or more and 1500 nm or less. With such a height (that is the thickness of the liquid crystal layer), phase modulation with sufficient width is possible to 2 π that is the ideal modulation amount.

### (2) Partition Part

The partition part is to divide the pixel region into two or more. In the case of dividing into two or more, there are no particular limitations as long as the control of liquid crystal alignment is possible, and it may be arranged in either X-axial direction or the Y-axial direction that are the orientation direction of the pixel electrodes, and may be arranged in the both. Also, the partition part is usually desired to be formed to connect to the wall part so that there is no space between the wall part and the pixel regions are completely separated, but it may not be connected to the wall part. The partition part is, for example, to equally divide the pixel region into two or more.

The partition part is arranged so as to divide one pixel region into two or more, that is, to form two or more of the liquid crystal-filling microspace corresponding to one pixel region.

### (a) Thickness

The thickness of the partition part is not particularly limited, but is preferably 50 nm or more and 400 nm or less, and further preferably 50 nm or more and 200 nm or less. With this thickness or less, sufficient opening can be secured, and the light utilization efficiency can be improved.

### (b) Height

The height of the partition part is not particularly limited, but is preferably 500 nm or more and 3000 nm or less, and further preferably 500 nm or more and 1500 nm or less. With such a height, it is sufficient to impart the liquid crystal orientation function to the liquid crystal-filling microspace.

In the present disclosure, as shown in FIG. 2, the height of the wall part 4A and the height of the partition part 4B may be the same and may be different.

In this manner, when the height of the partition part and the height of the wall part are different, they are usually formed so that the height of the partition part becomes smaller than the height of the wall part. In this case, when the height of the wall part is regarded as 100, the height of the partition part is preferably 50 or more, and particularly preferably 80 or more.

5. Base Layer (Base Layer with Groove)

The liquid crystal alignment member for spatial light phase modulation in the present embodiment includes a base layer connected to the lattice-shaped wall structure. The base layer is usually a dielectric layer formed in a process of forming the lattice-shaped wall structure, and is configured by the dielectric material that is the same as the dielectric material of the lattice-shaped wall structure. The base layer surrounds the liquid crystal-filling microspace together with the lattice-shaped wall structure, and a base groove extending to the second axial direction that is the longer axis direction of the liquid crystal-filling microspace is formed in the base layer.

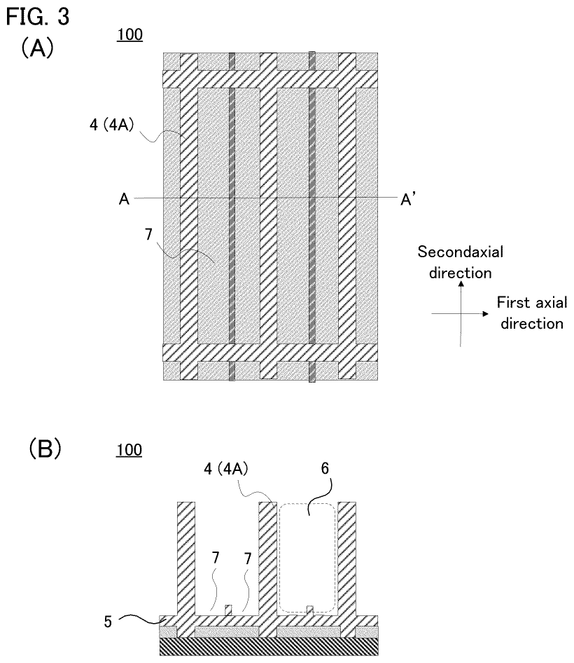

Two or more of the base groove are preferably arranged in the base layer corresponding to each liquid crystal-filling microspace. In FIG. 1, in the base layer 5 facing one liquid crystal-filling microspace 6, three base grooves 7 are formed. In FIG. 3, in the base layer 5 facing one liquid crystal-filling microspace 6, two base grooves 7 are formed. In this manner, since the liquid crystal-filling microspace including the shape anisotropy is arranged on the base layer including the base groove extending to the longer axis direction, the orientation of the liquid crystal can be more accurately controlled.

The shape of the base groove viewed from the thickness direction of the alignment member, that is the cross-sectional shape of the base groove is not particularly limited, and examples thereof may include rectangular and triangle. Also, the angle of the base groove may have curvature.

The ratio of the depth (D1) of the base groove with respect to the height (H1) of the lattice-shaped wall structure, which is D1/H1 is, for example, preferably 0.1 or more. With the above value or more, it is sufficient to impart high liquid crystal orientation function to the liquid crystal-filling microspace. Meanwhile, for example, the ratio is 0.5 or less and preferably 0.4 or less. With the above value or less, formation of the groove is easy, and the shape of the groove can be stably formed. Here, the depth (D1) of the base groove refers to the maximum depth of the groove as shown in FIG. 1.

The specific depth (D1) of the base groove is not particularly limited, and for example, it is preferably 100 nm or more. With the above value or more, high liquid crystal orientation function can be imparted to the liquid crystal-filling microspace. Meanwhile, for example, the depth is 500 nm or less, and preferably 400 nm or less. With the above value or less, the formation of the base groove is easy, and the shape of the base groove can be stably formed.

The width (G1) of the base groove is not particularly limited, and for example, it is preferably 50 nm or more, and more preferably 70 nm or more. Meanwhile, for example, the width is preferably 200 nm or less, and more preferably 150 nm or less. Here, the width (G1) of the base groove refers to the maximum width of the base groove as shown in FIG. 1.

The base groove is formed in the base layer so as to extend to the second axial direction of the liquid crystal-filling microspace, and is usually arranged in a linear shape. The base groove is preferably continuously formed, but may be interrupted on the way.

### 6. Liquid Crystal-Filling Microspace

A plurality of liquid crystal-filling microspace in the present embodiment is a space separated from each other by the lattice-shaped wall structure, and is disposed on the base layer. In other words, each liquid crystal-filling microspace is a space surrounded with the linear convex part. This liquid crystal-filling microspace includes a shape anisotropy in directions orthogonal to each other in the base portion plane to the extent the liquid crystal can be aligned. In other words, when a first axis and a second axis are designed so as to orthogonal to each other in a plane parallel to the base portion, the space width W_{A} of the first axial direction is shorter than the space width W_{B} of the second axial direction.

Such a flat surface (XY surface) shape of the liquid crystal-filling microspace is not particularly limited, and examples thereof may include shapes including a longer side (longer axis) and a shorter side (shorter axis) such as a rectangle, an ellipse, and a parallelogram. Such a space including the anisotropy enables control of the orientation of liquid crystal to be filled in. Further, in the present embodiment, the liquid crystal-filling microspace is arranged on the base layer including the base groove extending to the longer axial direction, and thus the orientation of the liquid crystal can be more accurately controlled.

In the present embodiment, the space width W_{A} of the first axial direction (shorter side or shorter axis direction) is preferably 3 μm or less. Further, the shorter the space width W_{A} of the first axial direction, the more preferable; 0.6 μm or less is preferable, and 0.3 μm or less is particularly preferable.

Also, the ratio of the length of the space width W_{B} of the second axial direction (longer side or longer axis direction) with respect to the space width W_{A} of the first axial direction (shorter side or shorter axis direction), which is W_{B}/W_{A}, in the liquid crystal-filling microspace is, preferably about 2 or more, and particularly preferably 2.5 or more. The upper limit is not particularly limited, and it may be infinite, but it may be usually 10 or less. In this range, the shape anisotropy in the directions orthogonal to each other in the base portion plane is sufficient, and thus the orientation of the liquid crystal can be certainly controlled by utilizing elasticity of the liquid crystal to be filled in.

In the present embodiment, either one or the both of the first axis and the second axis may match the matrix direction of the pixel electrodes disposed in the matrix.

In other words, when the pixel electrodes are disposed in the one dimensional matrix aligned in only the X-axial direction, either one of the first axial direction and the second axial direction may match the X-axial direction that is the arrangement direction of the pixel electrodes.

Also, when the pixel electrodes are disposed in the two dimensional matrix arranged in the X-axial direction and the Y-axial direction orthogonal to the X-axial direction, the first axial direction and the second axial direction may match the X-axial direction and the Y-axial direction that are the arrangement direction of the pixel electrodes. In other words, each liquid crystal-filling microspace includes shape anisotropy in the X-axial direction and the Y-axial direction that are the arrangement direction of the pixel electrodes, and the length of the side (axis) may be different in the X-axial direction and in the Y-axial direction.

### 6. Application

The liquid crystal alignment member for spatial light phase modulation of the present embodiment is suitably used as a liquid crystal alignment member for a reflecting type spatial light modulation element controlling a phase of incident light and reflected light while reflecting an incident light. Also, with the alignment member of the present embodiment, the liquid crystal can be controlled independently for each pixel region, and the light modulation element having a pixel pitch of 3 μm or less can be obtained. Thus, when the liquid crystal alignment member for spatial light phase modulation of the present embodiment is used in a display device, it is possible to secure a wide angle range in which the reproduced image can be observed, and thus can be suitably used for a holographic display, a stereoscopic display device, an ultra-high definition projector, or the like using optical diffraction.

### 7. Others

### (1) Adhesive Layer

In the present disclosure, an adhesive layer can be formed in order to improve adhesion of the base portion and the convex shaped structure. The adhesive layer is not particularly limited as long as it can improve the adhesion of the base portion and the convex shaped structure, known materials as the adhesive layer material can be used, and examples thereof may include a silane coupling material.

### (2) Light Absorbing Layer

In order to prevent the emission of non-modulated light, a light absorbing layer is preferably arranged on a surface of the base portion and on a surface layer of the lattice-shaped wall structure excluding the region (pixel region) where the pixel electrodes are formed. As the light absorbing layer, for example, a black pigment and a binder resin may be included. Examples of the black pigment may include titan black such as lower titanium oxide and titanium oxynitride, and carbon black. Also, the binder resin that is the main component of the light absorber preferably contains a photosensitive resin.

As the photosensitive resin, for example, one kind or more of a photosensitive resin including a photosensitive group such as a reactive vinyl group such as an acryl-based resin, an epoxy-based resin, a polyimide-based resin, a polycinnamic acid vinyl-based resin, and a cyclized rubber, can be used. In the acryl-based resin, for example, a photosensitive resin including an alkali-soluble resin, a multifunctional acrylate-based monomer, a photopolymerization initiator, and other additives, can be used as the resin component of the binder resin. Note that the binder resin may include known various additives such as a photosensitizer, a dispersant, a surfactant, a stabilizer, and a leveling agent, other than the above described materials.

### (3) Notch, Spacer

In order to improve fluidity of the liquid crystal at the time of filling, a spacer may be formed partially in the top part of the lattice-shaped wall structure. By arranging such a spacer, the height of the point where the spacer is formed can be different from the other height of the wall structure, and thus the liquid crystal can be filled with good fluidity. This spacer can be formed integrally of the same material as that of the lattice-shaped wall structure. Also, in order to improve the fluidity of the liquid crystal at the time of filling, a notch part may be partially arranged in the top part of the lattice-shaped wall structure.

### 8. Production Method

Next, an example of the method for producing the liquid crystal alignment member for spatial light phase modulation of the present disclosure will be shown. The liquid crystal alignment member for spatial light phase modulation of the present disclosure can be produced by arranging the base layer with groove and the lattice-shaped wall structure on the silicon substrate including pixel electrodes. The base layer with groove and the lattice-shaped wall structure in the present disclosure can be produced using known various processing techniques for forming fine patterns, and examples thereof may include a nano imprinting method and an etching method, and it is particularly preferably formed by the nano imprinting method. As the production method by the nano imprinting method, a dielectric layer is formed of a dielectric material such as a photocurable resin on the base portion, a mold including a pattern corresponding to the base layer with groove and the lattice-shaped wall structure is pushed against the layer, and then cured by irradiating light, and the mold is removed, so that the base layer with groove and the lattice-shaped wall structure are produced. Also, the production is also possible by preparing the base layer with groove and the lattice-shaped wall structure at the same time by the nano imprinting method or the like separately, and by adhering the lattice-shaped wall structure on the base portion.

### B. Liquid Crystal Alignment Member for Spatial Light Modulation (Second Embodiment)

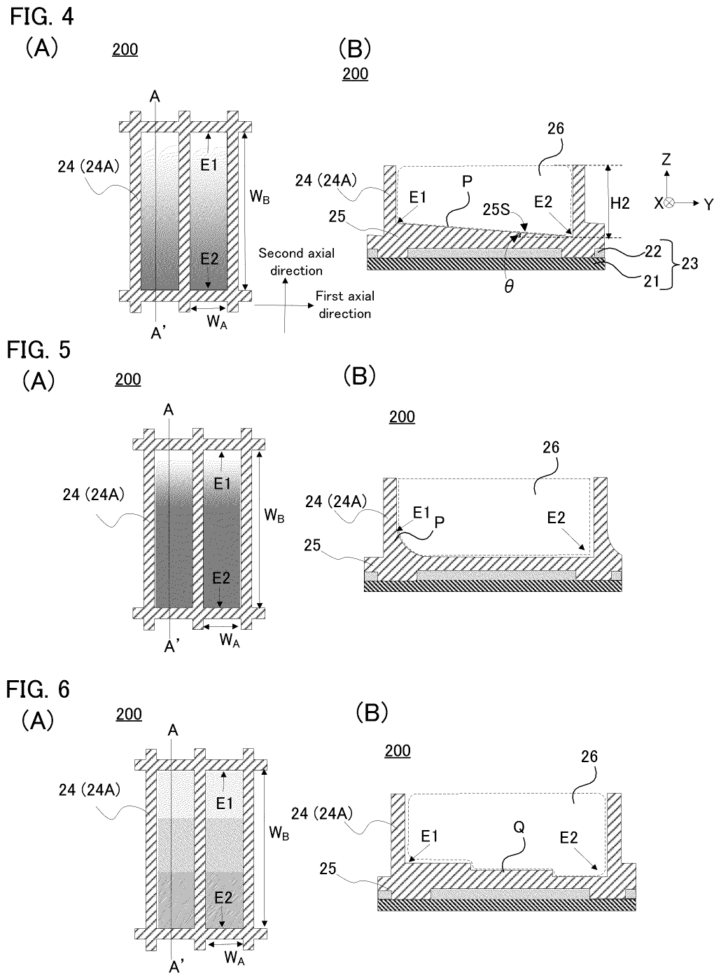

The liquid crystal alignment member for spatial light phase modulation (hereinafter also simply referred to as alignment member) of the present embodiment will be explained with reference to drawings. FIG. 4 to FIG. 7 are top views and schematic cross-sectional views illustrating an example of the liquid crystal alignment member for spatial light phase modulation of the present embodiment. Liquid crystal alignment member for spatial light phase modulation 200 of the present embodiment includes base portion 23 including silicon substrate 21, and pixel electrodes 22 arranged in a matrix with a period of 3 μm or less, disposed on a surface of the silicon substrate 21; lattice-shaped wall structure 24 in which a plurality of linear convex part is combined, arranged on the base portion 23 and configured by a dielectric material; base layer 25 connected to the lattice-shaped wall structure 24; and a plurality of liquid crystal-filling microspace 26 for filling a liquid crystal, that is separated from each other by the lattice-shaped wall structure 24, and is disposed on the base layer 25.

The lattice-shaped wall structure 24 is arranged at least between pixel regions where adjacent the pixel electrodes 22 are formed. In FIG. 4 to FIG. 7, the first axial direction is designed in the X-axial direction that is the matrix direction of the pixel electrodes, and the second axial direction is designed in the Y-axial direction that is the matrix direction of the pixel electrodes. The liquid crystal-filling microspace 26 separated from each other by the lattice-shaped wall structure 24 has a shape anisotropy in the first axial direction and the second axial direction orthogonal to each other in the base portion plane, and the space width W_{B} of the second axial direction is longer than the space width W_{A} of the first axial direction. Further, the base layer 25 surrounding the liquid crystal-filling microspace 26 together with the lattice-shaped wall structure 24 features a configuration in which at least one of slope P and step Q is formed, and thus is uneven thickness base layer 25 of which thickness differs in one end E1 and in the other end E2 in the second axial direction of the liquid crystal-filling microspace 26.

With the liquid crystal alignment member for spatial light phase modulation of the present embodiment, since the lattice-shaped wall structure is arranged at least between pixel regions where adjacent the pixel electrodes are formed, and the liquid crystal-filling microspace is separated from each other by the lattice-shaped wall structure, when a liquid crystal is filled and used as a light modulation element, electric field leakage from adjacent pixels and propagation of liquid crystal elastic force can be blocked even when the pixel pitch is narrow to 3 μm or less.

Also, at the same time, since one or two or more of the liquid crystal-filling microspace corresponding to each of the pixel electrodes having a narrow pixel pitch of 3 μm or less, includes shape anisotropy in the directions (first axial direction and the second axial direction) orthogonal to each other in the base portion plane, the liquid crystal alignment function can be imparted to the structure itself, and thus the orientation of the liquid crystal can be aligned even when there is no alignment film on the base portion. For this reason, it is possible to easily control the orientation of the liquid crystal independently in each pixel.

Further, in the second axial direction of the liquid crystal-filling microspace, the base layer can impart a pre-tilt angle slightly inclined with respect to the base portion plane to the liquid crystal molecules since the thicknesses differs in one end and in the other end. For example, it is described that the pre-tilt angle can be imparted by the slope or the step in documents such as Koichi Miyachi, Yuichiro Yamada, Naofumi Kimura and Shigeaki Mizushima, “The UV2A Technology for Large Size LCD-TV Panels,” ISSN-L 1883-2490/17/0013 2010 ITE and SID, Yu-Ping Kuo, Shih-Chyuan Fan Jiang, Chih-hung Shih, Wei-Ming Huang, “New MVA Design to Improve Color Washout for Mobile Applications,” ISSN-L 1883-2490/17/1799 2010 ITE and SID. In specific, in the above documents, a protrusion of which cross-section is a triangular or hemispherical is provided on one substrate surface, and when the liquid crystal orientation is slightly tilted on the inclined protrusion surface, the direction in which the liquid crystal orientation is tilted is controlled in an arbitrary direction when a voltage is applied.

In the present embodiment, the pre-tilt angle refers to an average inclination angle of the longer axial direction of the liquid crystal molecule to the base portion plane. The pre-tilt angle gives great influence to the operational characteristic (particularly the rising direction of liquid crystal molecules) when no voltage is applied. Thus, since the rotation direction of the liquid crystal molecules can be controlled by imparting the pre-tilt angle to the liquid crystal molecules, the orientation of the liquid crystal including the transitional orientation can be accurately controlled. Further, in the present embodiment, the above described function of blocking the leakage of electric field from the adjacent pixel electrode and propagation of the liquid crystal elastic force, and structure (lattice-shaped wall structure and uneven thickness base layer) including the liquid crystal alignment function and the pre-tilt angle imparting function, can be formed together at the same time.

The liquid crystal alignment member for spatial light phase modulation in the present embodiment is capable of aligning the liquid crystal molecules in a direction substantially horizontal to the base portion while imparting the pre-tilt angle when no voltage is applied to the liquid crystal layer. The alignment member of the present embodiment will be hereinafter described in details.

The silicon substrate, the pixel electrodes, the base portion, and the lattice-shaped wall structure in the present embodiment are the same as those described in “A. Liquid crystal alignment member for spatial light phase modulation (first embodiment)” above; thus, the descriptions herein are omitted.

### 1. Base Layer (Uneven Thickness Base Layer)

The liquid crystal alignment member for spatial light phase modulation in the present embodiment includes an uneven thickness base layer connected to the lattice-shaped wall structure. The base layer is usually a dielectric layer formed in a process of forming the lattice-shaped wall structure, and is configured by the same dielectric material as the dielectric material of the lattice-shaped wall structure. The uneven thickness base layer surrounds the liquid crystal-filling microspace together with the lattice-shaped wall structure, and its thickness differs in one end and in the other end, in the second axial direction of the liquid crystal-filling microspace.

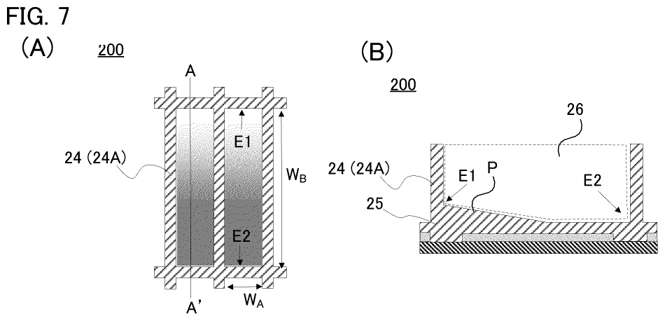

In specific, the uneven thickness base layer preferably includes at least one of a slope and a step in the second axial direction of the liquid crystal-filling microspace and thereby its thickness differs in one end and in the other end. In FIG. 4, the uneven thickness base layer 25 includes slope P that linearly inclines from one end E1 to the other end E2 in the second axial direction of the liquid crystal-filling microspace 26. In FIGS. 5A and 5B, the uneven thickness base layer 25 includes slope P having a curved surface shape in one end E1 in the second axial direction of the liquid crystal-filling microspace 26. In FIG. 6, the uneven thickness base layer 25 includes step Q from one end E1 to the other end E2 in the second axial direction of the liquid crystal-filling microspace 26. In FIG. 7, the base layer 25 includes slope P from one end E1 until on the way to the other end E2 in the second axial direction of the liquid crystal-filling microspace 26.

The difference in the thickness of one end (E1) and the other end (E2) in the second axial direction of the liquid crystal-filling microspace is, for example, preferably 200 nm or more. With the above value or more, it is sufficient thickness to impart the pre-tilt angle to the liquid crystal molecule, and the orientation of the liquid crystal can be more accurately controlled. Meanwhile, for example, the difference is 300 nm or less, and preferably 240 nm or less. With the above value or less, the liquid crystal-filling microspace with sufficient width can be secured.

The slope may be arranged in the whole region from one end E1 to the other end E2 in the second axial direction of the liquid crystal-filling microspace 26, and may be arranged in the partial region. Also, the inclination angle (θ) of the slope may be, for example, 3 degree or more. Meanwhile, for example, the angle is 20 degree or less, and may be 16 degree or less. In the above range, it is sufficient angle to impart the pre-tilt angle to the liquid crystal molecule, and the orientation of the liquid crystal can be more accurately controlled. In the present embodiment, the inclination angle (θ) of the slope is an angle formed by the surface of the base layer with respect to the base portion plane.

The step may be one and may be plural from one end E1 to the other end E2 in the second axial direction of the liquid crystal-filling microspace 26. The step may be arranged in the whole region, and may be arranged in the partial region.

In the present embodiment, the height of the lattice-shaped wall structure 24 refers to, as indicated with (H2) in FIG. 4, the maximum length of a length from the first surface 25S of the base layer 25 until the top part of the lattice-shaped wall structure 24 (linear convex part) in a direction orthogonal to the in-plane direction of the base layer 25.

Also, in the uneven thickness base layer, the thickness in one end and the other end in the first axial direction of the liquid crystal-filling microspace may be the same and may be different, but is preferably the same.

Further, in the uneven thickness base layer, a base groove extending to the second axial direction that is the longer axial direction of the liquid crystal-filling microspace may be formed. Such a groove is the same as that described in “A. Liquid crystal alignment member for spatial light phase modulation (first embodiment)” above; thus, the description herein is omitted.

### C. Spatial Light Modulation Element (First Embodiment)

The present disclosure provides a spatial light modulation element that is a reflecting type phase modulation element controlling a phase of incident light and reflected light while reflecting an incident light, the spatial light modulation element including: a transparent substrate, a common electrode arranged on one surface of the transparent substrate, the above described liquid crystal alignment member for spatial light phase modulation arranged on a surface of the common electrode that is opposite side to the transparent substrate, and a liquid crystal layer filled in the liquid crystal-filling microspace of the liquid crystal alignment member for spatial light phase modulation.

Note that the spatial light modulation element in the present embodiment is the one in which liquid crystal molecule filled in the liquid crystal-filling microspace is aligned (homogeneously aligned) in a direction substantially horizontal to the base portion when no voltage is applied. The spatial light modulation element of the present embodiment will be herein after described in details.

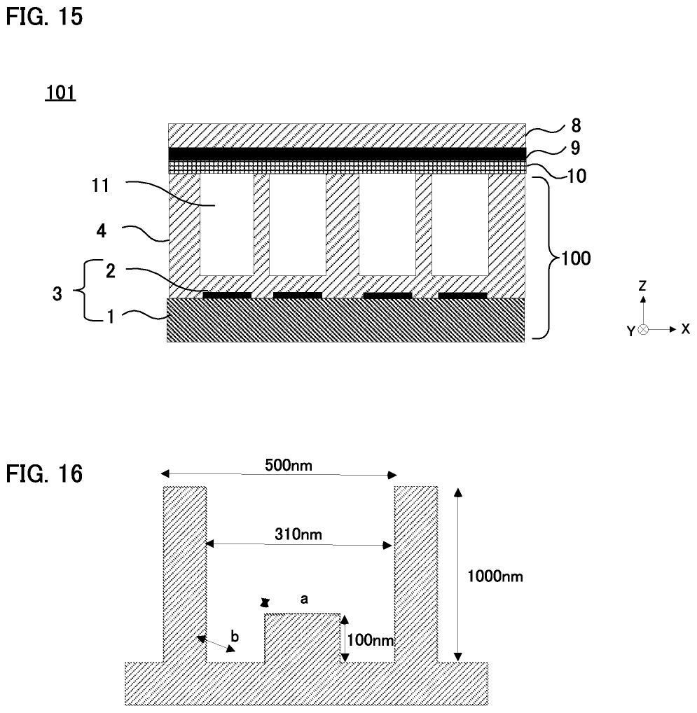

FIG. 15 is a schematic cross-sectional view illustrating an example of the spatial light modulation element of the present disclosure using the above described liquid crystal alignment member for spatial light phase modulation of the first embodiment. Spatial light modulation element 101 of the present disclosure is reflecting type spatial light phase modulation element 101 controlling a phase of incident light and reflected light while reflecting an incident light, and includes transparent substrate 8, common electrode 9 formed on the transparent substrate, the above described liquid crystal alignment member for spatial light phase modulation 100 of the first embodiment, and liquid crystal layer 11 filled in the liquid crystal-filling microspace of the liquid crystal alignment member for spatial light phase modulation. The spatial light modulation element 101 of the present disclosure may include alignment film 10 between the common electrode 9 and the liquid crystal alignment member for spatial light phase modulation 100 as shown in FIG. 15. The spatial light modulation element of the present disclosure will be hereinafter described.

### 1. Transparent Substrate

The transparent substrate configures a surface of the spatial light modulation element, and transmits light of specified wavelength incident from the surface of the spatial light modulation element to the inside of the spatial light modulation element. As the transparent substrate, a glass material such as quartz glass and alkali-free glass, and existing plastic substrate including polycarbonate-based, acryl-based, polyimide-based, polystyrene-based, and polyolefin-based plastic substrates can be used.

### 2. Common Electrode

The common electrode is formed on the back surface of the transparent substrate, and generally a transparent electrode can be used. Specific examples thereof may include ITO and IZO.

### 3. Liquid Crystal Alignment Member for Spatial Light Phase Modulation

The liquid crystal alignment member for spatial light phase modulation used in the spatial light modulation element of the present disclosure is the same as that explained in “A. Liquid crystal alignment member for spatial light phase modulation (first embodiment” above, or in “B. Liquid crystal alignment member for spatial light phase modulation (second embodiment)” above; thus, the description herein is omitted.

### 4. Liquid Crystal Layer

The liquid crystal layer in the present embodiment is not particularly limited as long as it is a liquid crystal including the dielectric anisotropy used for the light modulation element, and for example, a nematic crystal with excellent responsiveness is preferable, and in particular, a cyano-based, a fluorine-based, a biphenyl-based, a terphenyl-based, and a trough-based liquid crystal are useful. In specific, a liquid crystal material with a higher dielectric constant in the longer axial direction than that in the shorter axis of the molecular shape (that is, a liquid crystal (Np liquid crystal) with a positive dielectric anisotropy) can be used. In this case, the liquid crystal layer includes the Np liquid crystal, and a homogenous orientation (horizontal orientation) in which the liquid crystal molecules are initially aligned in parallel to the base portion and in the same direction, can be adopted. Also, in the Np liquid crystal, the liquid crystal molecules are arranged in parallel in the electric field direction when voltage is applied. Note that, in the phase modulation element, the liquid crystal material (Np liquid crystal) with a higher dielectric constant in the longer axial direction than that in the shorter axis is larger in the refractive index difference between the longer axial direction and the shorter axial direction, and it is easy to obtain a high modulation degree. For this reason, it is preferable to use the nematic liquid crystal having a higher dielectric constant in the longer axial direction of the molecule.

The liquid crystal layer modulates light according to the electric field formed by each pixel electrode. In other words, when voltage is applied to one pixel electrode by the later described driving measure, an electric field is formed between the common electrode and the pixel electrode. Then, the orientation direction of the liquid crystal molecules changes according to the magnitude of the electric field applied to the liquid crystal layer. When light is incident to the liquid crystal layer by transmitting the transparent substrate and the common electrode, this light is modulated by the aligned liquid crystal region while passing through the liquid crystal layer, and after reflected in the pixel electrode, modulated again by the liquid crystal layer to be taken out. At this time, the liquid crystal molecules change their alignment direction within the slope. As a result, a refractive index of the liquid crystal layer changes depending on the pixel position. The read light incident to the liquid crystal layer is phase-modulated by the refractive index change, reflected by the pixel electrode, and is output again from the incident surface.

### 5. Alignment Film

An alignment film may be formed on an end surface of the liquid crystal layer that is the common electrode side, in order to enforce the regulating force for aligning liquid crystal molecule groups in a fixed direction and to define the pre-tilt angle. Although known alignment films can be used, for example, one configured by a polymer material such as polyimide, and subjected to a rubbing treatment or the like on a contact surface with a liquid crystal layer, a photo-alignment film in which a polymer surface is molecular-oriented by ultraviolet light irradiation, an oblique vapor deposition film of SiOₓ, and the like can be applied.

### 6. Production Method

The spatial light modulation element of the present disclosure can be produced by, with a sealing material or the like, fixing the periphery of the above described liquid crystal alignment member for spatial light phase modulation and the transparent substrate including the common electrode in the state the positions are matched, and injecting the liquid crystal under vacuum, or dropping the liquid crystal under vacuum before bonding the substrate.

In the present disclosure, if necessary, the alignment member may be disposed in advance on the transparent substrate including the common electrode.

Also, in the transparent substrate side, the lattice-shaped wall structure described in “A. Liquid crystal alignment member for spatial light phase modulation 4. Lattice-shaped wall structure” may be disposed, and after injecting the liquid crystal, this and the base portion described in “A. Liquid crystal alignment member for spatial light phase modulation 3. Base portion” may be sealed with a sealing material or the like.

### D. Stereoscopic Display Device (First Embodiment)

The present disclosure provides a stereoscopic display device including the above described spatial light modulation element, and a driving measure for driving the pixel electrodes.

### 1. Spatial Light Modulation Element

The spatial light modulation element used in the stereoscopic display device of the present disclosure is the same as that explained in “C. Spatial light modulation element (first embodiment)” above; thus, the description herein is omitted.

### 2. Driving Measure

The driving measure for driving the pixel electrodes is a measure to control the voltage applied to each pixel electrode according to an optical image to be output from the spatial light modulation element. For example, a first driver circuit controlling the applied voltage of each pixel line aligned in the X-axial direction, and a second driver circuit controlling the applied voltage of each pixel line aligned in the Y-axial direction are included, and a specified voltage is applied between the pixel electrodes of pixels designated by the both driver circuits and the common electrode. Thereby, an electric field is generated in the liquid crystal layer. For example, it is possible to configure a stereoscopic display device in which light is incident to the spatial light modulation element, and interference of emitted light is controlled to form a three-dimensional spatial optical image at an arbitrary position. Alternatively, a spectacle-type stereoscopic display device can be configured.

### E. Liquid Crystal Alignment Member for Spatial Light Phase Modulation (Third Embodiment)

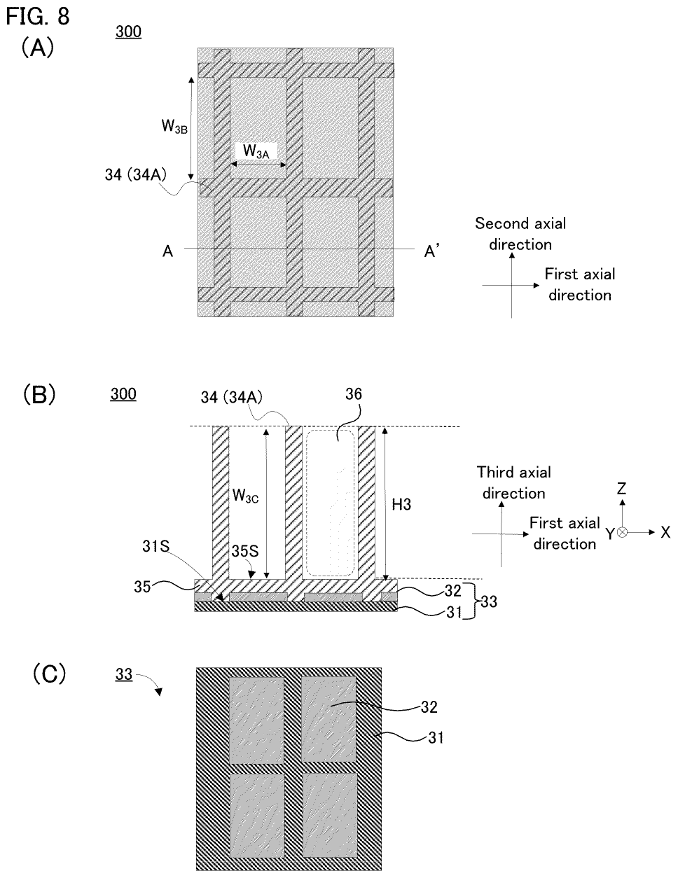

The liquid crystal alignment member for spatial light phase modulation (hereinafter also simply referred to as alignment member) of the present embodiment will be explained with reference to drawings. FIG. 8(A) is a top view illustrating an example of the alignment member of the present embodiment, FIG. 8(B) is a schematic cross-sectional view of A-A′ in FIG. 8(A), and FIG. 8(C) is a top view of the base portion in FIG. 8(B).

The liquid crystal alignment member for spatial light phase modulation 300 of the present embodiment includes: base portion 33 including silicon substrate 31, and pixel electrodes 32 arranged in a matrix with a period of 3 μm or less disposed on a surface of the silicon substrate 31; lattice-shaped high wall structure 34 in which a plurality of linear convex part is combined, arranged on the base portion 33 and configured by a dielectric material; base layer 35 connected to the lattice-shaped high wall structure 34; and a plurality of liquid crystal-filling microspace 36 for filling a liquid crystal, that is separated from each other by the lattice-shaped high wall structure 34 and arranged on base layer 35. The lattice-shaped high wall structure 34 is arranged at least between pixel regions where adjacent the pixel electrodes 32 are formed.

Further, when a first axis and a second axis are designed so as to orthogonal to each other in a plane parallel to the base portion 33 (in FIG. 8, the first axis is designed in the X-axial direction that is the matrix direction of the pixel electrodes 32, and the second axis is designed in the Y-axial direction that is the matrix direction of the pixel electrodes 32 and orthogonal to the first axial direction in a plane parallel to the base portion 33), and a third axis is further designed so as to vertical to a plane parallel to the base portion, and when in the liquid crystal-filling microspace 36, W_{3A} is a space width of the first axial direction, W_{3B} is a space width of a second axial direction, and W_{3C} is a space width of a third axial direction, the W_{3C} is larger than the W_{3A} and the W_{3B}, and at least one of W_{3C}/W_{3A} and W_{3C}/W_{3B} is 1.1 or more.

With the liquid crystal alignment member for spatial light phase modulation of the present embodiment, since the lattice-shaped high wall structure is arranged at least between pixel regions where adjacent the pixel electrodes are formed, and the liquid crystal-filling microspace is separated by the lattice-shaped high wall structure, when the liquid crystal is filled and used as a light modulation element, the electric field leakage from the adjacent pixel and the propagation of liquid crystal elastic force can be blocked even when the pixel pitch is narrow to 3 μm or less.

Also, at the same time, since one or two or more of the liquid crystal-filling microspace corresponding to each of the pixel electrode with a narrow pixel pitch of 3 μm or less includes the shape anisotropy in the first axial direction and the second axial direction in a plane parallel to the base portion, and in the third axial direction that is the vertical direction to the plane parallel to the base portion, a liquid crystal orientation function can be imparted to the structure itself, and thus the orientation of the liquid crystal can be aligned even when there is no alignment film on the base portion. For this reason, it is possible to easily control the orientation of the liquid crystal independently in each pixel.

Note that the liquid crystal alignment member for spatial light phase modulation in the present embodiment is a liquid crystal vertical alignment member for spatial light phase modulation capable of aligning the liquid crystal molecules in a direction substantially vertical to the base portion plane when no voltage is applied to the liquid crystal layer. The alignment member of the present embodiment will be hereinafter described in details.

The silicon substrate, the pixel electrodes, and the base portion in the present embodiment are the same as those described in “A. Liquid crystal alignment member for spatial light phase modulation (first embodiment)” above; thus, the descriptions herein are omitted.

### 1. Lattice-Shaped High Wall Structure

The thickness of the lattice-shaped high wall structure in the present embodiment is not particularly limited, but is preferably 50 nm or more and 400 nm or less, and further preferably 200 nm or less. Here, the thickness of the lattice-shaped high wall structure in the present embodiment refers to the thickness in non-crossing part of the linear convex part similarly to FIG. 1.

Also, the height of the lattice-shaped high wall structure in the present embodiment is not particularly limited as long as the space width W_{3C} of the third axial direction becomes larger than the space width W_{3A} of the first axial direction and the space width W_{3B} of the second axial direction.

In the present embodiment, the height of the lattice-shaped high wall structure 34 refers to, as indicated with (H3) in FIG. 8, when the alignment member 300 includes the base layer 35, the maximum length from the first surface 35S of the base layer 35 in the direction orthogonal to the in-plane direction of the base layer 35 until the top part of the wall structure 34 (linear convex part). Also, when the alignment member 300 does not include the base layer 35, the height of the lattice-shaped high wall structure 34 refers to a length from the first surface 31S of the silicon substrate 31 in the direction orthogonal to the in-plane direction of the silicon substrate 31 until the top part of the wall structure 34 (wall part).

The height of the lattice-shaped high wall structure is, for example, preferably 500 nm or more and 3000 nm or less, and particularly preferably 800 nm or more and 1500 nm or less.

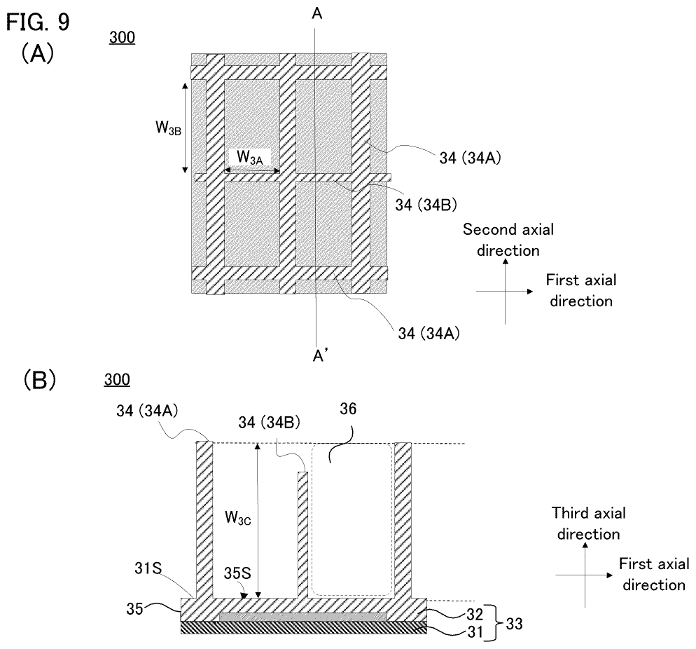

In the present embodiment also, as shown in FIG. 9, the lattice-shaped high wall structure 34 can be roughly classified into high wall part 34A arranged between the adjacent pixel regions, and high partition part 34B that divides one pixel region into two or more. The high wall part and the high partition part will be hereinafter respectively explained in details.

### (1) High Wall Part

The high wall part is arranged to separate the adjacent pixel regions, that is, arranged to surround each pixel region, and the configurations other than the height are the same as those of the wall part described in “A. Liquid crystal alignment member for spatial light phase modulation (first embodiment)” above.

The height of the high wall part in the present embodiment is not particularly limited, but is preferably 500 nm or more and 3000 nm or less, and further preferably 800 nm or more and 1500 nm or less. With such a height (that is the thickness of the liquid crystal layer), when the liquid crystal is filled and used as a light modulation element, the electric field leakage from the adjacent pixel and the propagation of liquid crystal elastic force can be certainly blocked, and also, the orientation of the liquid crystal can be aligned even when there is no alignment film on the base portion. Further, the liquid crystal-filling microspace with sufficient shape anisotropy to the plane parallel to the base portion can be obtained. Also, phase modulation with sufficient width is possible to 2 π that is the ideal modulation amount.

### (2) High Partition Part

The high partition part is to divide the pixel region into 2 or more, and the configurations other than the height are the same as those of the partition part described in “A. Liquid crystal alignment member for spatial light phase modulation (first embodiment” above.

The height of the high partition part is not particularly limited, but is preferably 500 nm or more and 3000 nm or less, and further preferably 500 nm or more and 1500 nm or less. With such a height, it is sufficient to impart the liquid crystal orientation function to the liquid crystal-filling microspace.

In the present embodiment, the heights of the high wall part and the high partition part may be the same, and as shown in FIG. 9, the heights of the high wall part 34A and the high partition part 34B may be different.

In this manner, when the heights of the high partition part and the high wall part are different, the height of the high partition part is usually formed smaller than the height of the high wall part. In this case, when the height of the high wall part is regarded as 100, the height of the high partition part is preferably 50 or more, and particularly preferably 80 or more. The reason therefor is that the liquid crystal orientation function may not be sufficient when the height of the high partition part is smaller than the above range.

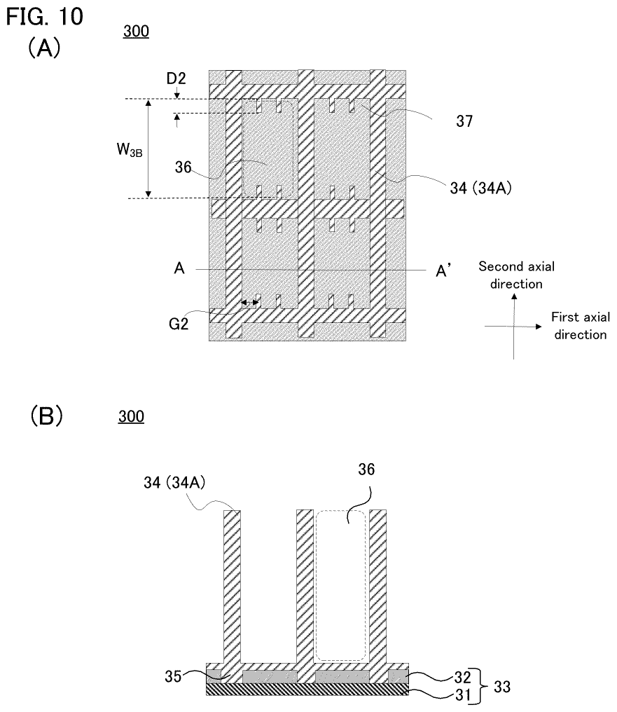

The lattice-shaped high wall structure in the present embodiment preferably includes wall groove 37 extending to the third axial direction in one surface or more among four surfaces facing to each of the liquid crystal-filling microspace 36 as shown in FIG. 10. In FIG. 10, three wall grooves 37 are respectively formed in two surfaces facing to each other among four surfaces facing to each of the liquid crystal-filling microspace 36. There are no particular limitations on the number of the wall groove per one surface, but it is preferably 2 or more.

In this manner, when the liquid crystal-filling microspace including the shape anisotropy faces the wall including the wall groove extending to the longer axial direction (third axial direction), the orientation of the liquid crystal can be more accurately controlled.

The shape of the wall groove in a plane view of the alignment member, that is the cross-sectional shape of the wall groove is not particularly limited, and examples thereof may include a rectangular and a triangle. Also, the angle of the wall groove may have a curvature.

The specific depth (D2) of the wall groove is not particularly limited, but for example, it is preferably 100 nm or more. With the above value or more, it is sufficient to impart high liquid crystal orientation function to the liquid crystal-filling microspace. Meanwhile, for example, the depth is 500 nm or less, and preferably 400 nm or less. With the above value or less, formation of the groove is easy, and the shape of the groove can be stably formed. Here, the depth (D2) of the wall groove refers to the maximum depth of the groove as shown in FIG. 10.

The width (G2) of the wall groove is not particularly limited, but for example, it is preferably 50 nm or more. Meanwhile, for example, it is preferably 70 nm or less.

The wall groove in the present embodiment is formed in the lattice-shaped high wall structure so as to extend to the third axial direction of the liquid crystal-filling microspace, and is usually arranged in a linear shape. The wall groove is preferably formed continuously, but may be interrupted on the way.

### 2. Liquid Crystal-Filling Microspace

A plurality of liquid crystal-filling microspace in the present embodiment is separated from each other by the lattice-shaped high wall structure, that is, each of the liquid crystal-filling microspace is a space surrounded with the linear convex part. This liquid crystal-filling microspace includes shape anisotropy in directions (first axial direction and second axial direction) in the base portion plane and in the third axial direction vertical to the plane parallel to the base portion, to the extent the liquid crystals are aligned.

In other words, when the first axis and the second axis are designed so as to orthogonal to each other in a plane parallel to the base portion, further, the third axis is designed in a vertical direction to the plane parallel to the base portion, W_{3A} is a space width of the first axial direction, W_{3B} is a space width of a second axial direction of the liquid crystal-filling microspace, and W_{3C} is a space width of a third axial direction, the W_{3C} is larger than the W_{3A} and the W_{3B}, and at least one of W_{3C}/W_{3A} and W_{3C}/W_{3B} is 1.1 or more. At least one of the W_{3C}/W_{3A} and the W_{3C}/W_{3B} is preferably 1.3 or more, and particularly preferably 1.5 or more. Either one or both of the first axis and the second axis may, for example, be designed to match the matrix direction of the pixel electrodes arranged in a matrix, in a plane parallel to the base portion.

The shape of the cross-section (XZ surface and YZ surface) of such a liquid crystal-filling microspace is not particularly limited, and examples thereof may include shapes including a long side (long axis) and a short side (short axis) such as a rectangular and a parallelogram. Such a space including the anisotropy enables control of the orientation of liquid crystal to be filled in.

The values of the space width W_{3A} of the first axial direction and the space width W_{3B} of the second axial direction may be the same or different. When the values of the space width W_{3A} of the first axial direction and the space width W_{3B} of the second axial direction are the same, the space width W_{3C} of the third axial direction satisfies W_{3C}>W_{3A}=W_{3B}. In this case, the ratio of the length of the space width W_{3C} of the third axial direction with respect to the space width W_{3A} of the first axial direction and the space width W_{3B} of the second axial direction, which is W_{3C}/W_{3A} and W_{3C}/W_{3B} is about 1.1 or more, preferably 1.3 or more, and particularly preferably 1.5 or more. In this range, the shape anisotropy is sufficient in the directions (first axial direction and the second axial direction) in the base portion plane and in the third axial direction that is the vertical direction to the plane parallel to the base portion, and thus, the orientation of the liquid crystal can be certainly controlled utilizing the elasticity of the liquid crystal to be filled in.

In the present embodiment, when the pixel electrodes are arranged in one dimensional matrix that is the alignment in only the X-axial direction, either one of the first axial direction and the second axial direction may match the X-axial direction that is the orientation direction of the pixel electrodes.

Also, when the pixel electrodes are arranged in the two dimensional matrix that is the alignment in X-axial direction and in Y-axial direction orthogonal to the X-axial direction, the first axial direction and the second axial direction preferably match the X-axial direction and the Y-axial direction that are the orientation directions of the pixel electrodes. In other words, each of the liquid crystal-filling microspace may or may not include shape anisotropy in the X-axial direction and in the Y-axial direction (XY plane) that are the orientation directions of the pixel electrodes, but includes shape anisotropy in the X-axial direction and in the X-axial direction (XZ plane) and in the Y-axial direction and in the Z-axial direction (YZ plane).

### 3. Base Layer

In the bottom part of the liquid crystal-filling microspace in the present embodiment, as shown in FIG. 8 to FIG. 10, there may be the base layer 35, and such a base layer may be removed to expose the pixel electrodes 32. The base layer 35 is usually configured by a dielectric material formed in the process of forming the lattice-shaped high wall structure. The base layer 35 is connected to the lattice-shaped high wall structure 34, and is surrounding both of the lattice-shaped high wall structure 34 and the liquid crystal-filling microspace 36.

Further, the base layer in the present embodiment is preferably an uneven thickness base layer of which thickness differs in one end and in the other end, in the second axial direction of the liquid crystal-filling microspace. When it is the uneven thickness base layer, orientation in a direction substantially horizontal to the base portion is possible while imparting the pre-tilt angle when voltage is applied.

The thickness of the base layer is preferably different in one end and in the other end by including at least one of a slope and a step in the second axial direction of the liquid crystal-filling microspace.

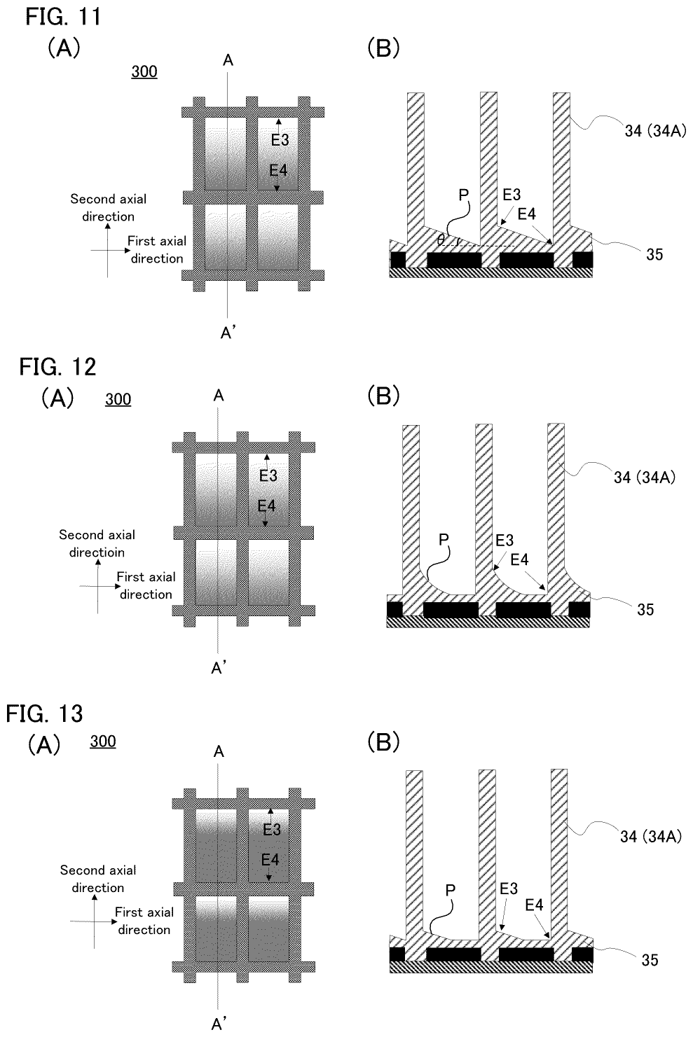

In FIG. 11, the base layer 35 includes slope P linearly inclining from one end E3 to the other end E4 in the second axial direction of the liquid crystal-filling microspace 36.

In FIG. 12, the base layer 35 includes slope P having a curve surface shape in one end E3 in the second axial direction of the liquid crystal-filling microspace 36.

In FIG. 13, the base layer 35 includes slope P from one end E1 until the way of the other end E2 in the second axial direction of the liquid crystal-filling microspace 36.

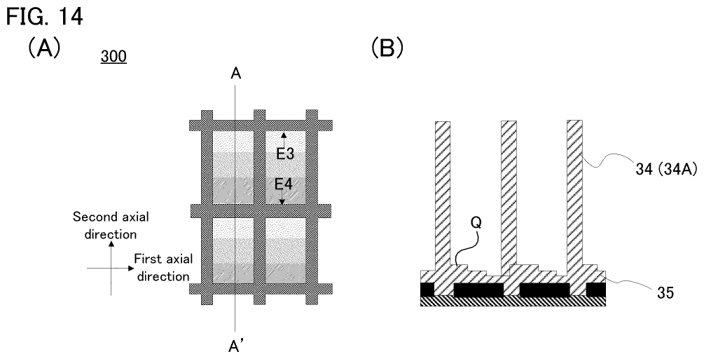

In FIG. 14, the base layer 35 includes step Q from one end E3 to the other end E4 in the second axial direction of the liquid crystal-filling microspace 36.

In the first axial direction or in the second axial direction of the liquid crystal-filling microspace, difference in the thickness of one end (E3) and the other end (E4) is, for example, preferably 200 nm or more. With the above value or more, it is sufficient thickness to impart the pre-tilt angle to the liquid crystal molecule, and the orientation of the liquid crystal can be more accurately controlled. Meanwhile, for example, the difference is 300 nm or less, and preferably 240 nm or less. With the above value or less, the liquid crystal-filling microspace with sufficient width can be secured.

The slope may be arranged in the whole region from one end E3 to the other end E4 in the first axial direction or in the second axial direction of the liquid crystal-filling microspace, and may be arranged in a partial region.

Also, the inclination angle of the slope may be, for example, 3 degree or more. Meanwhile, for example, the angle is 20 degree or less, and may be 16 degree or less. With the above range, the rotation direction of the liquid crystal molecules can be controlled since the pre-tilt angle is imparted to the liquid crystal molecules when voltage is applied, and thus the orientation of the liquid crystal can be more accurately controlled. In the present embodiment, the inclination angle (θ) of the slope is an angle formed by the surface of the base layer with respect to the base portion plane.

The step may be one or plural from one end E3 to the other end E4 in the second axial direction of the liquid crystal-filling microspace 36. The step may be arranged in the whole region, and may be arranged partially.

### F. Spatial Light Modulation Element (Second Embodiment)

The present disclosure provides a spatial light modulation element that is a reflecting type phase modulation element controlling a phase of incident light and reflected light while reflecting an incident light, the spatial light modulation element including: a transparent substrate, a common electrode arranged on one surface of the transparent substrate, the above described liquid crystal alignment member for spatial light phase modulation of the third embodiment arranged on a surface of the common electrode that is opposite side to the transparent substrate, and a liquid crystal layer filled in the liquid crystal-filling microspace of the liquid crystal alignment member for spatial light phase modulation.

Note that the spatial light modulation element in the present embodiment is one in which liquid crystal molecules filled in the liquid crystal-filling microspace are aligned in a direction substantially vertical to the base portion when no voltage is applied. The spatial light modulation element of the present embodiment will be hereinafter described in details.

The transparent substrate and the common electrode are the same as those described in “C. Spatial light modulation element (first embodiment” above; thus, the descriptions herein are omitted.

### 1. Liquid Crystal Alignment Member for Spatial Light Phase Modulation

The liquid crystal alignment member for spatial light modulation used in the spatial light modulation element of the present embodiment is the same as that described in “E. Liquid crystal alignment member for spatial light phase modulation (third embodiment)” above; thus, the description herein is omitted.

### 2. Liquid Crystal Layer

The liquid crystal layer in the present embodiment is not particularly limited as long as it is a liquid crystal including the dielectric anisotropy used for the light modulation element, and for example, a nematic crystal with excellent responsiveness is preferable, and in particular, a cyano-based, a fluorine-based, a biphenyl-based, a terphenyl-based, and a trough-based liquid crystal are useful. In specific, a liquid crystal material of which dielectric constant in the shorter axial direction is higher than that of the longer axis of the molecule shape (that is, liquid crystal (Nn liquid crystal) with negative dielectric constant anisotropy) can be used. In this case, the liquid crystal layer includes the Nn liquid crystal, and a homeotropic alignment (vertical) in which the liquid crystal molecules are initially aligned in the same direction vertical to the base portion can be adopted. Also, in the Nn liquid crystal, liquid crystal molecules are aligned vertically in the electric field direction when voltage is applied.

The other configurations and the production method of the spatial light modulation element of the present embodiment are the same as those described in “E. Liquid crystal alignment member for spatial light phase modulation (third embodiment)” above; thus, the descriptions herein are omitted.

### G. Stereoscopic Display Device (Second Embodiment)

The present embodiment provides a stereoscopic display device including the above described spatial light modulation element of the second embodiment, and a driving measure for driving the pixel electrodes.

### 1. Spatial Light Modulation Element

The spatial light modulation element used in the stereoscopic display device of the present embodiment is the same as that described in “F. Spatial light modulation element (second embodiment)” above; thus, the description herein is omitted.

### 2. Driving Measure

The driving measure used for the stereoscopic display device of the present embodiment is the same as that described in “D. Stereoscopic display device (first embodiment)” above; thus, the description herein is omitted.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

The present disclosure will be hereinafter explained in further details with reference to Examples and Comparative Examples.

### Example 1

On a glass substrate, an acryl resin layer composed of a photocurable resin mainly composed of acrylate was formed, a nano-imprinting processing was performed thereto to produce an evaluation sample of the alignment member of the first embodiment including the base layer with groove and the lattice-shaped wall structure having a cross-sectional shape shown in FIG. 16.

The top view is shown in FIG. 18(A). The thickness of the lattice-shaped wall structure was 190 nm, the height of the lattice-shaped wall structure was 1000 nm, the space width (W_{A}) of the shorter axial (short side) direction of the liquid crystal-filling microspace was 310 nm, and the space width (W_{B}) of the longer axial (long side) direction was 830 nm. Also, the base layer included two base grooves having the width ((b) in FIG. 16) of 94 nm and the depth of 100 nm along the longer axial direction (second axial direction). Also, the distance ((a) in FIG. 16) between adjacent base grooves was 123 nm.

### Examples 2 to 6

An evaluation sample of the alignment member including the base layer with base groove and the lattice-shaped wall structure was respectively produced in the same manner as in Example 1, except that the space width (W_{A}) of the shorter axial (short side) direction of the liquid crystal-filling microspace, the space width (W_{B}) of the longer axial (long side) direction, the number of the base groove, and the distance (a) between the adjacent base grooves were changed to have the top view of FIGS. 18(A) and (B), as shown in below Table 1.

### Comparative Example 1

An evaluation sample of the alignment member of the first embodiment including the base layer and the lattice-shaped wall structure was produced in the same manner as in Example 1, except that the base groove was not formed in the base layer.

### Comparative Examples 2 to 4

An evaluation sample of the alignment member of the first embodiment including the base layer with groove and the lattice-shaped wall structure was respectively produced in the same manner as in Example 1, except that the space width (W_{A}) of the shorter axial (short side) direction of the liquid crystal-filling microspace, and the space width (W_{B}) of the longer axial (long side) direction were changed, and the base groove was formed along the shorter side direction (first axial direction) of the liquid crystal-filling microspace with the number of the base groove, and the distance (a) between the adjacent base grooves to have the top view of FIG. 18(C) to (E), as shown in below Table 1.

### [Evaluation]

### <No Alignment Film>

A liquid crystal material was filled in the liquid crystal-filling microspaces produced in Examples 1 to 6 and Comparative Example 1 to 4, and the periphery of a common electrode made of IZO and a polycarbonate substrate was fixed by a sealing material by overlapping them so that the polycarbonate substrate was on the outermost surface, and thereby an evaluation sample of the spatial light modulation element was produced. As the liquid crystal material, cyanobiphenyl-based E7 (from Merck KGAA) that is a nematic liquid crystal was used.

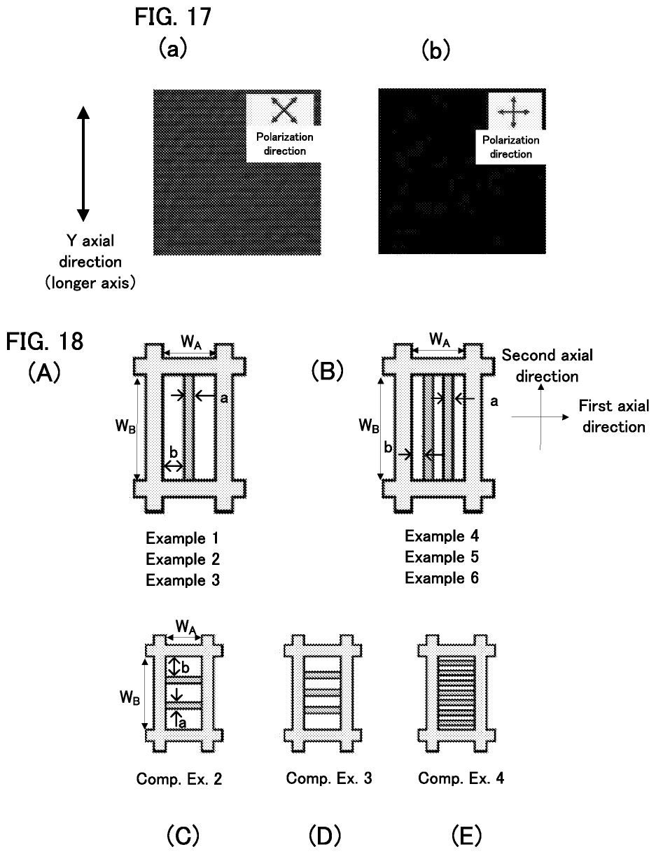

Two polarizing plates were arranged in a crossed Nicols state shifted by 90°, and the spatial light modulation element using the alignment member produced in Example 1 was disposed between the polarizing plates, and a light-dark state was observed by a 100-fold objective lens. FIG. 17(a) shows a deflection microscope observation result when the angle difference between the Y-axial (longer axis) direction and the polarization direction of the polarizing plate was 45°, and FIG. 17(b) shows a deflection microscope observation result when the angle difference between the Y-axial direction and the polarization direction of the polarizing plate was 0°.

In Example 1, when the angle difference between the Y-axial direction and the polarization direction of the polarizing plate was 45°, the state was light (in FIG. 17(a)), and when the angle difference between the Y-axial direction and the polarization direction of the polarizing plate was 0°, the state was almost completely black (FIG. 17(b)).

Also, regarding Examples 1 to 6 and Comparative Examples 1 to 4, the ratio (R) of the average transmittance (T_{45°}) of the light state when the angle difference between the Y-axial direction and the polarization direction of the polarizing plate was 45°, and the average transmittance (T_{0°}) of the dark state when the angle difference was 0° was calculated by the below equation (average transmittance ratio), and used as an evaluation index.

$$R = ( {T}_{45 °} ) / ( {T}_{0 °} )$$

When the liquid crystals are aligned uniformly, the polarization axis rotates when the polarized light passes through the liquid crystals, and thus transmitted through the polarizing plate arranged in a crossed Nicols state. In other words, the higher the ratio R of the average transmittance, the more uniformly the liquid crystals are aligned in the intended direction. The results are shown in Table 1.

### [Evaluation]

### <With Alignment Film>

An evaluation sample of the spatial light modulation element was produced in the same manner as the above <no alignment film>, except that a polycarbonate substrate in which an alignment film was formed was used instead of the polycarbonate substrate in the above <no alignment film>, and the polycarbonate substrate was arranged so as to be in the outermost surface, and the average transmittance was calculated. As the alignment film, a polyimide-based rubbing alignment film AL1254 (from JSR) was used. The results are shown in Table 2.

No alignment film

TABLE 1

| | | | | | T_{45°} | T_{0°} | |
|---|---|---|---|---|---|---|---|
| | | | | | Average | Average | Average |
| | The number | W_{A} | W_{B} | a | Transmittance | Transmittance | Transmittance |
| | of grooves | [nm] | [nm] | [nm] | [%] | [%] | ratio |
| Ex. 1 | 2 | 310 | 830 | 123 | 4.594 | 0.037 | 123.8 |
| Ex. 2 | 2 | 341 | 826 | 170 | 5.521 | 0.06 | 91.4 |
| Ex. 3 | 2 | 340 | 843 | 72 | 5.701 | 0.108 | 52.9 |
| Ex. 4 | 3 | 357 | 832 | 95 | 4.287 | 0.109 | 39.5 |
| Ex. 5 | 3 | 357 | 842 | 85 | 4.83 | 0.015 | 332.1 |
| Ex. 6 | 3 | 346 | 843 | 70 | 3.858 | 0.012 | 316.3 |
| Comp. | 0 | 313 | 804 | — | 4.981 | 0.334 | 14.9 |
| Ex. 1 | | | | | | | |
| Comp. | 3 | 352 | 803 | 195 | 2.052 | 0.145 | 14.2 |
| Ex. 2 | | | | | | | |
| Comp. | 4 | 374 | 804 | 135 | 1.537 | 0.071 | 21.5 |
| Ex. 3 | | | | | | | |
| Comp. | 8 | 352 | 821 | 73 | 0.749 | 0.056 | 13.3 |
| Ex. 4 | | | | | | | |

With alignment film

TABLE 2

| | | | | | T_{45°} | T_{O°} | |
|---|---|---|---|---|---|---|---|
| | | | | | Average | Average | Average |
| | The number | W_{A} | W_{B} | a | Transmittance | Transmittance | Transmittance |
| | of grooves | [nm] | [nm] | [nm] | [%] | [%] | ratio |
| Ex. 1 | 2 | 310 | 830 | 123 | 12.291 | 0.04 | 305.1 |
| Ex. 2 | 2 | 341 | 826 | 170 | 17.022 | 0.038 | 452.3 |
| Ex. 3 | 2 | 340 | 843 | 72 | 16.001 | 0.051 | 311.6 |
| Ex. 4 | 3 | 357 | 832 | 95 | 16.714 | 0.043 | 389 |
| Ex. 5 | 3 | 357 | 842 | 85 | 13.632 | 0.028 | 492.8 |
| Ex. 6 | 3 | 346 | 843 | 70 | 17.683 | 0.035 | 506.9 |
| Comp. | 0 | 313 | 804 | — | 13.571 | 0.118 | 115 |
| Ex. 1 | | | | | | | |
| Comp. | 3 | 352 | 803 | 195 | 14.994 | 0.214 | 70 |
| Ex. 2 | | | | | | | |
| Comp. | 4 | 374 | 804 | 135 | 10.501 | 0.104 | 100.8 |
| Ex. 3 | | | | | | | |
| Comp. | 8 | 352 | 821 | 73 | 9.846 | 0.065 | 151.6 |
| Ex. 4 | | | | | | | |

From the results of Table 1 and Table 2, the average transmittance ratio of Examples 1 to 6 was respectively higher compared to that of Comparative Examples 1 to 4 in both cases of with alignment film and no alignment film, and it was confirmed that the orientation of the liquid crystals was further aligned by the base layer in which the base groove was formed along the longer axial direction.

That is, the present disclosure provides the following inventions:

[1]

A liquid crystal alignment member for spatial light phase modulation comprising:
a base portion including a silicon substrate, and pixel electrodes arranged in a matrix with a period of 3 μm or less disposed on a surface of the silicon substrate;
a lattice-shaped wall structure in which a plurality of linear convex part is combined, arranged on the base portion and configured by a dielectric material;
a base layer configured by the dielectric material, connected to the lattice-shaped wall structure; and
a plurality of liquid crystal-filling microspace for filling a liquid crystal, that is separated from each other by the lattice-shaped wall structure, and is disposed on the base layer, wherein
the lattice-shaped wall structure is arranged at least between pixel regions where adjacent the pixel electrodes are formed;
when a first axis and a second axis are designed so as to orthogonal to each other in a plane parallel to the base portion,
the liquid crystal-filling microspace includes shape anisotropy in a first axial direction and a second axial direction;
when W_{A} is a space width of the first axial direction and W_{B} is a space width of the second axial direction, the W_{A} is a smaller value than the W_{B}; and
the base layer is a base layer with a groove, in which a base groove extending to the second axial direction of the liquid crystal-filling microspace is formed.

[2]

The liquid crystal alignment member for spatial light phase modulation according to [1], wherein two or more of the base groove are arranged in the base layer corresponding to the liquid crystal-filling microspace.

[3]

A liquid crystal alignment member for spatial light phase modulation comprising:
a base portion including a silicon substrate, and pixel electrodes arranged in a matrix with a period of 3 μm or less disposed on a surface of the silicon substrate;
a lattice-shaped wall structure in which a plurality of linear convex part is combined, arranged on the base portion and configured by a dielectric material;
a base layer configured by the dielectric material, connected to the lattice-shaped wall structure; and
a plurality of liquid crystal-filling microspace for filling a liquid crystal, that is separated from each other by the lattice-shaped wall structure, and is disposed on the base layer, wherein
the lattice-shaped wall structure is arranged at least between pixel regions where adjacent the pixel electrodes are formed;
when a first axis and a second axis are designed so as to orthogonal to each other in a plane parallel to the base portion,
the liquid crystal-filling microspace includes shape anisotropy in a first axial direction and a second axial direction;
when W_{A} is a space width of the first axial direction and W_{B} is a space width of the second axial direction, the W_{A} is a smaller value than the W_{B}; and
the base layer is an uneven thickness base layer of which thickness differs in one end and in the other end, in the second axial direction of the liquid crystal-filling microspace.

[4]

The liquid crystal alignment member for spatial light phase modulation according to [3] wherein the uneven thickness base layer includes at least one of a slope and a step in the second axial direction of the liquid crystal-filling microspace.

[5]

The liquid crystal alignment member for spatial light phase modulation according to any one of [1] to [4], wherein the W_{A} is 3 μm or less.

[6]

The liquid crystal alignment member for spatial light phase modulation according to any one of [1] to [5], wherein a ratio of the W_{B} with respect to the W_{A}, which is W_{B}/W_{A}, is 2 or more.

[7]

A reflecting type spatial light phase modulation element controlling a phase of incident light and reflected light while reflecting an incident light,
the spatial light modulation element comprising: a transparent substrate, a common electrode arranged on one surface of the transparent substrate, the liquid crystal alignment member for spatial light phase modulation according to any one of [1] to [6] arranged on a surface of the common electrode that is opposite side to the transparent substrate, and a liquid crystal layer filled in the liquid crystal-filling microspace of the liquid crystal alignment member for spatial light phase modulation.

[8]

The spatial light modulation element according to [7], wherein an alignment film is arranged between the common electrode and the liquid crystal alignment member for spatial light phase modulation.

[9]

A stereoscopic display device comprising the spatial light modulation element according to [7] or [8], and a driving measure for driving the pixel electrodes.

[10]

A liquid crystal alignment member for spatial light phase modulation comprising:
a base portion including a silicon substrate, and pixel electrodes arranged in a matrix with a period of 3 μm or less disposed on a surface of the silicon substrate;
a lattice-shaped high wall structure in which a plurality of linear convex part is combined, arranged on the base portion and configured by a dielectric material; and
a plurality of liquid crystal-filling microspace for filling a liquid crystal, that is separated from each other by the lattice-shaped high wall structure, wherein
the lattice-shaped high wall structure is arranged at least between pixel regions where adjacent the pixel electrodes are formed;
when a first axis and a second axis are designed so as to orthogonal to each other in a plane parallel to the base portion, and a third axis is further designed so as to vertical to a plane parallel to the base portion, and
when in the liquid crystal-filling microspace, W_{3A} is a space width of the first axial direction, W_{3B} is a space width of a second axial direction, and W_{3C} is a space width of a third axial direction, the W_{3C} is larger than the W_{3A} and the W_{3B}, and at least one of W_{3C}/W_{3A} and W_{3C}/W_{3B} is 1.1 or more.

[11]

The liquid crystal alignment member for spatial light phase modulation according to [10], wherein at least one of the W_{3C}/W_{3A} and the W_{3C}/W_{3B} is 1.3 or more.

[12]

The liquid crystal alignment member for spatial light phase modulation according to or [11], wherein the W3C is 800 nm or more.

[13]

The liquid crystal alignment member for spatial light phase modulation according to any one of [10] to [12], wherein the lattice-shaped high wall structure includes a wall groove extending to the third axial direction in one surface or more among four surfaces facing to the liquid crystal-filling microspace.

[14]

The liquid crystal alignment member for spatial light phase modulation according to claim 10, further comprising: a base layer that is connected to the lattice-shaped high wall structure, and is surrounding both of the lattice-shaped high wall structure and the liquid crystal-filling microspace, wherein
the base layer is configured by the dielectric material, and a thickness of the base layer differs in one end and in the other end, in the first axial direction or the second axial direction of the liquid crystal-filling microspace.

[15]

The liquid crystal alignment member for spatial light phase modulation according to [14], wherein the base layer includes at least one of a slope and a step in the first axial direction or the second axial direction of the liquid crystal-filling microspace.

[16]

A reflecting type spatial light phase modulation element controlling a phase of incident light and reflected light while reflecting an incident light,
the spatial light modulation element comprising: a transparent substrate, a common electrode arranged on one surface of the transparent substrate, the liquid crystal alignment member for spatial light phase modulation according to any one of [10] to [15] arranged on a surface of the common electrode that is opposite side to the transparent substrate, and a liquid crystal layer filled in the liquid crystal-filling microspace of the liquid crystal alignment member for spatial light phase modulation.

[17]

A stereoscopic display device comprising the spatial light modulation element according to [16], and a driving measure for driving the pixel electrodes.

### REFERENCE SIGNS LIST

1 silicon substrate
2 pixel electrodes
3 base portion
4 lattice-shaped wall structure
5 base layer
6 liquid crystal-filling microspace
100 liquid crystal alignment member for spatial light phase modulation

1.-17. (canceled)

18. A liquid crystal alignment member for spatial light phase modulation comprising:
a base portion including a silicon substrate, and pixel electrodes arranged in a matrix with a period of 3 μm or less, disposed on a surface of the silicon substrate;
a lattice-shaped wall structure in which a plurality of linear convex part is combined, arranged on the base portion and configured by a dielectric material;
a base layer configured by the dielectric material, connected to the lattice-shaped wall structure; and
a plurality of liquid crystal-filling microspace for filling a liquid crystal, that is separated from each other by the lattice-shaped wall structure, and is disposed on the base layer, wherein
the lattice-shaped wall structure is arranged at least between pixel regions where adjacent the pixel electrodes are formed;
when a first axis and a second axis are designed so as to orthogonal to each other in a plane parallel to the base portion,
the liquid crystal-filling microspace includes shape anisotropy in a first axial direction and a second axial direction;
when W_{A} is a space width of the first axial direction and W_{B} is a space width of the second axial direction, the W_{A} is a smaller value than the W_{B}; and
the base layer is a base layer with a groove, in which a base groove extending to the second axial direction of the liquid crystal-filling microspace is formed.

19. The liquid crystal alignment member for spatial light phase modulation according to claim 18, wherein two or more of the base groove are arranged in the base layer corresponding to the liquid crystal-filling microspace.

20. A liquid crystal alignment member for spatial light phase modulation comprising:
a base portion including a silicon substrate, and pixel electrodes arranged in a matrix with a period of 3 μm or less, disposed on a surface of the silicon substrate;
a lattice-shaped wall structure in which a plurality of linear convex part is combined, arranged on the base portion and configured by a dielectric material;
a base layer configured by the dielectric material, connected to the lattice-shaped wall structure; and
a plurality of liquid crystal-filling microspace for filling a liquid crystal, that is separated from each other by the lattice-shaped wall structure, and is disposed on the base layer, wherein
the lattice-shaped wall structure is arranged at least between pixel regions where adjacent the pixel electrodes are formed;
when a first axis and a second axis are designed so as to orthogonal to each other in a plane parallel to the base portion,
the liquid crystal-filling microspace includes shape anisotropy in a first axial direction and a second axial direction;
when W_{A} is a space width of the first axial direction and W_{B} is a space width of the second axial direction, the W_{A} is a smaller value than the W_{B}; and
the base layer is an uneven thickness base layer of which thickness differs in one end and in the other end, in the second axial direction of the liquid crystal-filling microspace.

21. The liquid crystal alignment member for spatial light phase modulation according to claim 20 wherein the uneven thickness base layer includes at least one of a slope and a step in the second axial direction of the liquid crystal-filling microspace.

22. The liquid crystal alignment member for spatial light phase modulation according to claim 18, wherein the W_{A} is 3 μm or less.

23. The liquid crystal alignment member for spatial light phase modulation according to claim 20, wherein the W_{A} is 3 μm or less.

24. The liquid crystal alignment member for spatial light phase modulation according to claim 18, wherein a ratio of the W_{B} with respect to the W_{A}, which is W_{B}/W_{A}, is 2 or more.

25. The liquid crystal alignment member for spatial light phase modulation according to claim 20, wherein a ratio of the W_{B} with respect to the W_{A}, which is W_{B}/W_{A}, is 2 or more.

26. A spatial light modulation element that is a reflecting type spatial light phase modulation element controlling a phase of incident light and reflected light while reflecting an incident light, the spatial light modulation element comprising:
a transparent substrate, a common electrode arranged on one surface of the transparent substrate, the liquid crystal alignment member for spatial light phase modulation according to claim 18 arranged on a surface of the common electrode that is opposite side to the transparent substrate, and a liquid crystal layer filled in the liquid crystal-filling microspace of the liquid crystal alignment member for spatial light phase modulation.

27. The spatial light modulation element according to claim 26, wherein an alignment film is arranged between the common electrode and the liquid crystal alignment member for spatial light phase modulation.

28. A stereoscopic display device comprising the spatial light modulation element according to claim 26, and a driving measure for driving the pixel electrodes.

29. A liquid crystal alignment member for spatial light phase modulation comprising:
a base portion including a silicon substrate, and pixel electrodes arranged in a matrix with a period of 3 μm or less disposed on a surface of the silicon substrate;
a lattice-shaped high wall structure in which a plurality of linear convex part is combined, arranged on the base portion and configured by a dielectric material; and
a plurality of liquid crystal-filling microspace for filling a liquid crystal, that is separated from each other by the lattice-shaped high wall structure, wherein the lattice-shaped high wall structure is arranged at least between pixel regions where adjacent the pixel electrodes are formed;
when a first axis and a second axis are designed so as to orthogonal to each other in a plane parallel to the base portion, and a third axis is further designed so as to vertical to a plane parallel to the base portion, and
when in the liquid crystal-filling microspace, W_{3A} is a space width of the first axial direction, W_{3B} is a space width of a second axial direction, and W_{3C} is a space width of a third axial direction, the W_{3C} is larger than the W_{3A} and the W_{3B}, and at least one of W_{3C}/W_{3A} and W_{3C}/W_{3B} is 1.1 or more.

30. The liquid crystal alignment member for spatial light phase modulation according to claim 29, wherein at least one of the W_{3C}/W_{3A} and the W_{3C}/W_{3B} is 1.3 or more.

31. The liquid crystal alignment member for spatial light phase modulation according to claim 29, wherein the W_{3C} is 800 nm or more.

32. The liquid crystal alignment member for spatial light phase modulation according to claim 29, wherein the lattice-shaped high wall structure includes a wall groove extending to the third axial direction in one surface or more among four surfaces facing to the liquid crystal-filling microspace.

33. The liquid crystal alignment member for spatial light phase modulation according to claim 29, further comprising:
a base layer that is connected to the lattice-shaped high wall structure, and is surrounding both of the lattice-shaped high wall structure and the liquid crystal-filling microspace, wherein
the base layer is configured by the dielectric material, and a thickness of the base layer differs in one end and in the other end, in the first axial direction or the second axial direction of the liquid crystal-filling microspace.

34. The liquid crystal alignment member for spatial light phase modulation according to claim 33, wherein the base layer includes at least one of a slope and a step in the first axial direction or the second axial direction of the liquid crystal-filling microspace.

35. A reflecting type spatial light phase modulation element controlling a phase of incident light and reflected light while reflecting an incident light, the spatial light modulation element comprising:
a transparent substrate, a common electrode arranged on one surface of the transparent substrate, the liquid crystal alignment member for spatial light phase modulation according to claim 29 arranged on a surface of the common electrode that is opposite side to the transparent substrate, and a liquid crystal layer filled in the liquid crystal-filling microspace of the liquid crystal alignment member for spatial light phase modulation.

36. A stereoscopic display device comprising the spatial light modulation element according to claim 35, and a driving measure for driving the pixel electrodes.
